(19) United States
(12) Patent Application Publication
(10) Pub. No.: US 2002/0193972 A1
(43) Pub. Date: Dec. 19, 2002

(54) Workshop facility design and operation support system enabling verification of the entire workshop to be performed easily

(75) Inventors: Yoshihisa Kudo, Iwata-shi (JP); Katsumi Morishita, Iwata-shi (JP); Masayuki Kaimi, Iwata-shi (JP); Hideaki Kamei, Iwata-shi (JP); Takeshi Maruyama, Iwata-shi (JP); Koji Sugimura, Iwata-shi (JP)

Correspondence Address: SUGHRUE, MION, ZINN, MACPEAK & SEAS, 2100 Pennsylvania Avenue, N.W., Washington, DC, 20037, US

(73) Assignee: NTN CORPORATION

(21) Appl. No.: 09/993,715

(22) Filed: Nov. 27, 2001

(30) Foreign Application Priority Data
Jun. 14, 2001 (JP) 2001-179758
Jun. 14, 2001 (JP) 2001-179759
Jun. 14, 2001 (JP) 2001-179760
Jun. 14, 2001 (JP) 2001-179761

(51) Int. Cl. G06F 17/50

(52) U.S. Cl. 703/1

(57) ABSTRACT

A workshop facility designing and operating method of the invention is for authoring a virtual workshop that is a data model of a workshop newly organized in part or in its entirety. After the organization, simulating means causes the virtual workshop to perform a quasi-production activity to verify a production state and a physical distribution state. An actual workshop is then constructed that matches with the verified virtual workshop. The constructed actual workshop is remote monitored and a result of this monitoring is compared with a result of verification during a virtual workshop verification process. In this way, verification of the workshop in its entirety can be performed simply so that workshop deployment such as a new set-up of a production line and change in process step of the existing line can be carried out efficiently and quickly in a short time. Remote monitoring of the constructed workshop can also be performed properly.

### BACKGROUND OF THE INVENTION

1. Field of the Invention

The present invention relates to a workshop facility designing and operating method and a support system for supporting a new setup of a production line for the production of new products and for change in process step of the existing line to thereby facilitate operation after construction.

The present invention also relates to a virtual workshop system and a virtual workshop-remote monitoring link system for supporting a new setup of a production line for the production of new products and for change in process step of the existing line to thereby facilitate operation after construction.

The present invention again relates to a method of changing a production line and its process step for mass-producing such products as mechanical components or the like, by performing a grinding operation, a turning operation or the like.

The present invention furthermore relates to a large area workshop production management system for collectively managing a production performed in a plurality of workshops established at various places, for example, various places in the world.

2. Description of the Prior Art

When it comes to mass-produced products such as mechanical component, for example, bearings and constant speed joint and so on, dedicated production lines one for each product are assembled. In such production lines, similar products, but having slightly different specifications are accommodated by changing an arrangement and/or process conditions. Where they cannot be accommodated by the change in arrangement, the production line is rearranged or newly set up. In the case of the products that are to become new goods, it is often that new production lines are set up. When the new lines are to be set up or when the existing lines are rearranged, deployment to a workshop is carried out after facilities and a group of facilities have been designed and contents of the design have been evaluated.

However, where the production line is newly set up or rearranged, not only are contents to be evaluated many, but workshop deployment is carried out using dedicated facilities for each product and, therefore, a relatively long period of time of development is required. Also, in view of a single-sided aspect, a process and facility design tends to result from evaluation and it often occur that after the workshop deployment rearrangement is required. By way of example, a process step of a low productivities, a so-called a bottle-necked process step tends to occur, resulting in difficulty for the workshop as a whole to perform a production activity efficiently. For this reason, rearrangement is necessitated after the workshop deployment.

Also, when the workshop is to be deployed, in the case of products of a new technology and new facilities, no technician at a field site cannot take any action and an experienced technician is dispatched to the field site to provide the technological support, resulting in shortage of technicians. Also, a trouble occurs after the workshop has been operated subsequent to the workshop deployment, and no countermeasure to the trouble can be taken at the field site.

With respect to those problems, evaluation based on simulation of virtual facilities has been suggested in numerous ways. Also, development of a remote monitoring technology for remote monitoring the workshop is in progress.

However, any of the conventional simulating means is a simulating means designed for application to a single facility or a single-purpose simulating means designed for application to a certain process step and is unable to perform a comprehensive evaluation. On the other hand, the conventional remote monitoring technology is considered independent from the simulating technology before the workshop deployment. For this reason, results of simulation are in no way reflected in the remote monitoring.

Also, in terms of demands from the market and a world-wide production planning, the necessity often occurs to change the process step in the production line in the workshop.

However, the conventional production line is such that the whole of each production facility is of a peculiar structure and, therefore, rearrangement of the production line is not easy to achieve. By way of example, in the production line for the production of a rolling bearing assembly, a grinding machine for grinding an outer race groove, a grinding machine for grinding an inner periphery of an inner race, a grinding machine for grinding an inner race groove and other are necessitated as production facilities, but these grinding machines are such that the entire facility is of a peculiar design and, therefore, rearrangement of the production line requires new introduction of the individual facilities in their entirety. Where the facilities are moved in their entirety, these facilities have different sizes and positions of delivery and discharge of works in these facilities differ from one facility to another and, therefore, new introduction of transport devices is correspondingly required. Also, the facilities that are no longer in use are required to be stored in their entirety, requiring a relatively large space for storage thereof.

If in place of the dedicated machine a versatile machine is used for each of the facilities in the production line, the process step can easily be changed, but the production line tends to become large in scale and the efficiency of utilization of each facility would be lowered, posing an economic problem.

On the other hand, in a machine tool, there is a dedicated unitary equipment that is standardized in the ISO standard or the like. According to it, important components forming the machine tool, for example, a main shaft head, a column, a bed and others are standardized for each unit and designed to have a compatibility with each other, and they are machines adapted to process particular works by combining them. However, it remains as a change in morphology of the production facility itself.

In the meantime, in industries having workshops, that provide a production base, at various countries of the world, production management is carried uniquely for each of the workshops. In the event that production does not catch up in those workshops, although production may be asked for at different workshops, all that occur are change in process step of the production line at the workshop asking for the production and also at the workshop asked for production. Also, if the workshop is asked for the production, the production plan is re-planned at such workshop where production was asked for.

For the reason discussed above, the workshops located in the various countries of the world are not effectively operated and some of the workshops come to be good for nothing, resulting in increase of the cost and delay in date of delivery. Also, where the production is asked for, the products requested cannot be manufactured without change effected to the process step in the production line at the workshop where the production is asked for and, since change in process step requires a substantial amount of time, it often occurs that the request to produce cannot be accepted.

### SUMMARY OF THE INVENTION

Accordingly, a first object of the present invention is to provide a workshop facility designing and operating method and a support system, wherein verification of the workshop in its entirety can be performed simply so that workshop deployment such as a new set-up of a highly efficient production line and change in process step of the existing line can be carried out quickly in a short time and remote monitoring of the constructed workshop can also be performed properly.

A second object of the present invention is to provide a virtual workshop system that is effective to facilitate a new setup of a production line for the production of new products or change of the products and to facilitate change in process step of the existing line and that is also effective to facilitate verification the workshop as a whole so that a highly efficient production line can be developed with reduction in period required to develop the production line.

A third object of the present invention is to provide a virtual workshop-remote monitoring link system wherein results of verification brought about by simulation can be effectively utilized and the remote monitoring of the workshop can be performed properly.

A fourth object of the present invention is to provide a workshop verifying system complex that is effective to facilitate a new setup of a production line for the production of new products or change of the products and to facilitate change in process step of the existing line and that is also effective to facilitate verification of the workshop as a whole so that a highly efficient production line can be developed with reduction in period required to develop the production line.

A fifth object of the present invention is to provide a production line that can be changed easily and a method changing a process step thereof.

A sixth object of the present invention is to provide a large area workshop production management system, which as a result of common sharing and transparency of business, physical distribution and production information, a number of workshops located in a large area can be efficiently operated to thereby reduce the cost and also reduce the period required before the date of delivery.

A seventh object of the present invention is to facilitate in any desired fashion change of the place of production and the morphology of production in consideration of demands and production costs.

An eighth object of the present invention is to strengthen a production technical force by means of remote monitoring and remote maintenance.

In order to accomplish the first object of the present invention, in a first aspect of the present invention, there is provided a workshop facility designing and operating method which includes a virtual workshop verifying process, a workshop deployment process and a remote monitoring process. During the virtual workshop verifying process, a virtual workshop that is a data model of an existing or newly established workshop having a portion or the whole that is newly designed is authored and a production state is verified by means of a simulating means by causing the virtual workshop to perform a quasi-production activity. The workshop referred to above is a workshop newly designed in part or in its entirety at the existing workshop, or a workshop entirely newly established based on a new design and others. During the workshop deployment process, an actual workshop utilizing a data model of the virtual workshop so verified is constructed. During the remote monitoring process, the actual workshop so constructed is remote monitored and a result of remote monitoring and the verification performed during the virtual workshop verifying process are compared with each other.

According to this method, since the virtual workshop that has been modeled based on data is authored and is then caused by the simulating means to perform the quasi-production activity to verify a production state, verification of the workshop in its entirety can be performed easily. For this reason, deployment of the new setup of the highly efficient production line and change in process step of the existing line can be performed in a short time, and the necessity of rearrangement to be performed after the workshop deployment can be eliminated. By this advance verification, it is possible to reduce the facility costs and the stock advantageously. Also, since the actual workshop is constructed based on the data model of the virtual workshop verified by the simulation and the actual workshop is then remote monitored to provide monitoring results which are subsequently compared with results of verification during the simulation, the results of the simulation can be effectively utilized in remote monitoring to facilitate a proper remote monitoring of the newly constructed workshop. By way of example, if there is a difference between the remote monitoring results and the simulation results, the simulation is again performed with conditions of the virtual workshop renewed or changed, to thereby achieve a proper maintenance.

In order to accomplish the first object of the present invention, in a second aspect of the present invention, the virtual workshop verifying process, the workshop deployment process and the remote monitoring process may be designed as follows. Specifically, during the virtual workshop verifying process, a virtual workshop that is a data model of an existing or newly established workshop having a portion or the whole that is newly designed, functions of production facilities and physical distribution facilities and information on a layout of these facilities are authored. A production state and a physical distribution state on the layout are verified by causing the virtual workshop to perform the quasi-production activity by means of a simulating means. During the workshop deployment process, an actual workshop utilizing the facilities and the layout in the data model of the virtual workshop so verified is constructed. During the remote monitoring process, the production state and the physical distribution state of the facilities in the layout employed in the actual workshop so constructed are remote monitored and the result of remote monitoring and the result of the verification performed are compared.

The production facility is arranged in a plural number to thereby define the production line. The physical distribution facility includes a transport apparatus and a storage facility out of the production line and a work transport apparatus within the production line. The simulating means referred to above outputs to a display device a layout diagram and a display descriptive of the state of flow of goods on the layout diagram. By way of example, it outputs a physical distribution line diagram. The display descriptive of the state of flow of goods on the layout diagram may be a graphical representation and/or alphanumerical representation. For the production state, for example, the productivity, that is, the amount of production per unitary time, and the operativity of the facilities are monitored.

Specifically, in this workshop facility designing and operating method of the present invention, the virtual workshop may include a plurality of virtual facilities, which are models of individual facilities. In such case, the simulating means has a facility simulating section for verifying each of the virtual facilities and an overall simulating section for unifying results of verification of the individual facilities performed by the facility simulating section to thereby apply them to the layout. According to this, the individual virtual facilities are simulated and result of verification of them can, after having been unified, applied to the layout.

The facility simulating section for the virtual facilities of a production facility is preferably capable of setting an operating condition and an adjusting condition settable of the production facility and also capable of performing verification appropriate to the operating condition and the adjusting condition that has been set. Also, the facility simulating section is preferably capable of verifying with respect to change in arrangement of the facility. In this way, the verification can be performed corresponding to change in the adjusting condition and the operating condition variously, or change in the condition for the arrangement variously.

During the verifying process performed by the simulating means a quality of a product being produced is preferably one of items that are to be verified.

The facility simulating section is preferably capable of performing verification by causing a program, which is executed by a numerical controlled apparatus or a programmable logic controller of the production facility, to be quasi-executed. By causing the program, which is executed by a numerical controlled apparatus or a programmable logic controller of the production facility, to be quasi-executed, verification closely related to an actual process can be performed.

Preferably, the simulating means is capable of performing verification corresponding to change in process step resulting from change in morphology of the facility of the workshop. By way of example, verification is possible that corresponds to change in process step resulting from change of jigs, tools and others. By performing the verification corresponding to the change in process step resulting from change in morphology of the facility, a wide range of verification can be carried out to thereby achieve a further optimization.

Each production facility is a dedicated unitary equipment in which modular units are interchangeably fitted one at a time to a common process machine, and the simulating means is preferably capable of performing verification corresponding to change of the modular units.

If the production facility is a dedicated unitary equipment, a freedom of change of the process step is large and the change of the process step can be performed in a short time. By performing the verification at the time the process step is changed by changing the modular units, a further optimum production line can be constructed in a short period of time.

In order to accomplish the first object of the present invention, in a third aspect of the present invention, there is provided a workshop facility design and operation support system which includes a virtual workshop authoring means for authoring a virtual workshop that is a model constructed according to layout information on functions of various production facilities and physical distribution facilities of a workshop, and a simulating means for verifying a production state and a physical distribution state on the layout by causing the virtual workshop to perform a quasi-production activity, and a remote monitoring means for remote monitoring the production state and the physical distribution state of the facilities in the layout employed in an actual workshop constructed according to the model of the virtual workshop so verified.

With this system, verification of the workshop as a whole can be performed simply, a workshop deployment such as a new setup of a production and change of the process step of the existing line can be performed efficiently and easily in a short time, and the result of simulation can be effectively used for remote monitoring so that the workshop constructed can be properly remote monitored.

In order to accomplish the second object of the present invention, in a fourth aspect of the present invention, there is provided a virtual workshop system for verifying a workshop wherein a plurality of production facilities are dedicated unitary equipments having modular units that can be interchangeably fitted one at a time to a process machine of a common specification. This virtual workshop system includes a virtual workshop authoring means for authoring a virtual workshop that is a model constructed based on information on functions of various production facilities and physical distribution facilities of the workshop and an layout of those facilities, and a simulating means for verifying a production state and a physical distribution state on the layout by causing the virtual workshop so authored to perform a quasi-production activity. The simulating means is capable of verifying the production state and physical distribution state when the modular units of the production facility are changed.

With this virtual workshop system, since it is provided with the virtual workshop authoring means for authoring the virtual workshop that is a data model and a simulating means for verifying a production state and a physical distribution state by causing the virtual workshop so authored to perform a quasi-production activity, the verification of the workshop as a whole can be performed simply. Since the production facility in the actual workshop is a dedicated unitary equipment in which modular units are interchangeably fitted one at a time to a process machine of a common specification, a freedom of change of the process step is large. With the use of such a production facility, since the simulating means enables verification of the production state and the physical distribution state at the time the modular units of the production facility are changed, verification of the production line of various process steps in which the modular units are changed can be carried out efficiently, thereby enabling the production line, in which features of the dedicated unitary equipment are effectively embodied, can be constructed. For this reason, new setup of the production line with respect to the change of the products to be manufactured and others and change of the process step of the existing line can be performed easily, and the verification of the workshop as a whole can also be performed easily, wherefore not only can an efficient production line be developed, but also the period of development can be shortened. Also, the facility cost and the stock can also be reduced.

In order to accomplish the second object of the present invention, in a fifth aspect of the present invention, the virtual workshop system is such that the virtual workshop authoring means and the simulating means are structured, for example, as follows. The virtual workshop authoring means is capable of authoring the virtual workshop that is a model constructed based on data of the layout of the facilities and functions of the production facilities and the physical distribution facilities of the actual workshop. The simulating means causes the virtual workshop so constructed to perform a quasi-production activity so that the production state and the physical distribution state on the layout can be verified. Some of the production facilities discussed above are arranged in a plural number to define a production line, and the plural production facilities that are constituent elements of this production line are a dedicated unitary equipment in which modular units can be interchangeably fitted one at a time to a process machine of a common specification. The simulating means referred to above is capable of performing verification appropriate to various changes of the production line including change of the modular units of the production facility.

With this structure, new setup of the production line with respect to the change of the products to be manufactured and others and change of the process step of the existing line can be performed easily, and the verification of the workshop as a whole cal also be performed easily, wherefore not only can an efficient production line be developed, but also the period of development can be shortened.

In order to accomplish the third object of the present invention, in a sixth aspect of the present invention, there is provided a virtual workshop-remote monitoring link system which includes the virtual workshop system discussed above, a remote monitoring system for remote monitoring an actual workshop corresponding to this virtual workshop, and a link means for performing a linking process between the virtual workshop system and the remote monitoring system.

With this virtual workshop-remote monitoring link system of the type discussed above, since there is provided the link means for performing a link process between the virtual workshop system and the remote monitoring system, the result of simulation can be more effectively utilized in the remote monitoring and the workshop constructed can be properly remote monitored.

In order to accomplish the fourth object of the present invention, in a seventh aspect of the present invention, there is provided a workshop-verifying system complex which is made up of the actual workshop and the virtual workshop system. The actual workshop includes a production line defined by production facilities and physical distribution facilities, a plurality of production facilities that form respective line constituent elements, each facility being a dedicated unitary equipment in which modular units are interchangeably fitted one at a time to a common process machine, and the virtual workshop system is a virtual workshop system of the present invention.

With this workshop-verifying system complex, since the plural production facilities that form respective line constituent elements of the actual workshop are dedicated unitary equipments in which the modular units can be interchangeably fitted one at a time to a common process machine, change of the modular units makes it possible for the process step of the production line to be performed easily. Since the production facilities of which production step can be changed and the virtual workshop system of the present invention are combined, not only can the period of development of the workshop be reduced, but the production can be optimized.

In order to accomplish the fifth object of the present invention, in an eighth aspect of the present invention, there is provided a production line which includes a plurality of production facilities and a plurality of physical distribution facilities. The plural production facilities form respective line constituent elements, each facility being a dedicated unitary equipment in which modular units are interchangeably fitted one at a time to a common process machine, and a process step can be changed by changing the modular units of the production facilities. The physical distribution facilities referred to above may include, for example, work transport apparatuses.

With this production line of the type discussed above, by changing the modular units for each of the production facilities, the production performance of the respective production facility can be changed to facilitate change of the process step of the production line. For this reason, the production line effective to manufacture products that cannot accommodate change in arrangement can easily be constructed merely by changing the modular units of the existing production line. Accordingly, in the workshop, a simple change makes it possible to increase the number of types of products that can be manufactured.

In order to accomplish the fifth object of the present invention, in a ninth aspect of the present invention, there is provided a method of changing a process step in a production line for changing the process step of the production line made up of a plurality of production facilities and a plurality of physical distribution facilities. The plural production facilities form respective line constituent elements, each facility being employed in the form of a dedicated unitary equipment in which modular units are interchangeably fitted one at a time to a process machine of a common specification, and the process step can be changed by changing one of the modular units of the production facilities.

Thus, since the process step can be changed by changing the modular units, various process steps can be easily changed and, therefore, control or decontrol and rearrangement of the plural production lines can easily be performed. By way of example, while different processes have hitherto been performed by the plural production facilities in one production line, the plural production facilities can be used to perform the same process merely by changing the modular units to thereby provide a dedicated line capable of giving rise to a large amount of production. Conversely, the production lines using the plural production facilities that are used to perform the same process can be changed into the production lines capable of performing different processes merely by changing the modular units.

In order to accomplish the sixth to eighth objects of the present invention, in a tenth aspect of the present invention, there is provided a large area workshop production management system which includes a united virtual workshop system including a plurality of virtual workshop systems unified together, said plural virtual workshop systems corresponding to respective actual workshops at various places, a united remote monitoring system for remote monitoring a production record of each of the actual workshop at the various places, a collective order control and management system for controlling and managing order information at various business establishments, a physical distribution controlling and monitoring system for controlling and monitoring physical distribution state at the various places, and a production planning means. Each of the virtual workshop system is comprised of a simulating means for verifying a production state by causing the virtual workshop, that is a data model of the actual workshop, to perform a quasi-production activity. The production planning means referred to above is operable to formulate a production plan to be shared by the actual workshops, according to information acquired from the united virtual workshop system, the united remote monitoring system, the collective order control and management system and the physical distribution controlling and monitoring system and also operable to give a production instruction to each of the actual workshop based on the production plan so formulated.

With this large area workshop production management system, since it includes the united remote monitoring system, the collective order control and management system and the physical distribution controlling and monitoring system, the large area business, physical distribution and production records can be recognized collectively. Also, since it includes the united virtual workshop system in which the plural virtual workshop systems corresponding to the actual workshops at the various places are united together, the virtual workshop systems can be caused to perform a quasi-production activity and prediction of the production that can be performed in the workshops can be easily and accurately carried out. For this reason, by the production planning means, a dynamic production plan can be set up in which the workshops located in the large area can be efficiently operated, and accordingly, not only can the cost be reduced, but the period required before the date of delivery can be shortened.

Preferably, the production planning means is operable to cause the united virtual workshop system to perform verification based on information acquired from the united remote monitoring system, the order control and management system and the physical distribution controlling and monitoring system and also operable to automatically formulate a production plan to be shared by the workshops according to a result of such verification. A capability of changing the automatically formulated production plan by the operator is also preferred.

In order to accomplish the sixth to eighth objects of the present invention, in an eleventh aspect of the present invention, there is provided a unified production management large area workshop facility which includes actual workshops at various places, a large area workshop production management system for performing a production management of those actual workshops, and a communication network means for communicating between the actual workshops and the large area workshop production management system, wherein the large area workshop production management system is the large area workshop management system discussed above, and wherein each of the actual workshops includes means for transmitting information on at least a production record to the united remote monitoring system in the large area workshop production management system.

According to this structure of the present invention, as a result of common sharing and transparency of business, physical distribution and production information, a number of workshops located in a large area can be efficiently operated to thereby reduce the cost and also reduce the period required before the date of delivery.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an explanatory diagram showing a conceptual structure of a virtual workshop system used in a preferred embodiment of the present invention;

FIG. 2 is an explanatory diagram showing a conceptual structure of a virtual workshop shown in FIG. 1;

FIG. 3 is an explanatory diagram showing a conceptual structure of a designing, operating and supporting system;

FIG. 4 is a block diagram showing a conceptual structure of a remote monitoring system;

FIG. 5 is an explanatory diagram showing the manner of monitoring performed by the remote monitoring system;

FIG. 6 is an explanatory diagram showing an example of interactive graphics displayed on a display device;

FIG. 7 is an explanatory diagram showing a conceptual structure of a linking system for linking the virtual workshop system and the remote monitoring system;

FIG. 8 is a schematic diagram showing the virtual workshop system in comparison with an example of a graphics display of the remote monitoring system;

FIG. 9 is an explanatory diagram showing a graphics display of an layout of the virtual workshop system;

FIG. 10 is an explanatory diagram showing an example of a display screen displaying a production line of the virtual workshop system;

FIG. 11 is a process step explanatory diagram showing a concept of the method of designing and operating a workshop facility according to one embodiment of the present invention;

FIG. 12 is an explanatory diagram showing a concept of communication relation between a large area workshop production management system and its related elements;

FIG. 13 is an explanatory diagram showing a conceptual structure of the large area workshop production management system;

FIG. 14 is an explanatory diagram showing an example of a hardware structure of the large area workshop production management system;

FIG. 15A is a block diagram showing a conceptual structure of a production planning means;

FIG. 15B is an block diagram of a production instruction shown in FIG. 15A;

FIG. 16 is an explanatory diagram showing an example of a layout of an actual workshop;

FIG. 17 is an explanatory diagram showing a layout portion in which a production line is juxtaposed in an actual workshop;

FIG. 18 is a perspective view showing a dedicated unitary equipment in which the production facility in the production line is used as an inner race groove grinding machine;

FIG. 19 is a perspective view showing a dedicated unitary equipment in which the production facility in the production line is used as an inner race inner periphery grinding machine;

FIG. 20 a perspective view showing a dedicated unitary equipment in which the production facility in the production line is used as an outer race groove grinding machine;

FIG. 21 is a perspective view showing a process machine of a common specification in the production facility;

FIG. 22 is a perspective view showing a portion of the production line shown in FIG. 17;

FIG. 23 is a perspective view showing an example of change of a process step of the production line shown in FIG. 17;

FIG. 24 is a plan view showing the production facilities in the production line in comparison with the conventional facilities;

FIG. 25 is a sectional view of a rolling bearing assembly which is an example of products manufactured in the workshop shown in FIG. 17; and

FIG. 26 is a sectional view of a constant speed ball joint which is an example of products manufactured in the workshop shown in FIG. 17.

### DETAILED DESCRIPTION OF THE EMBODIMENTS

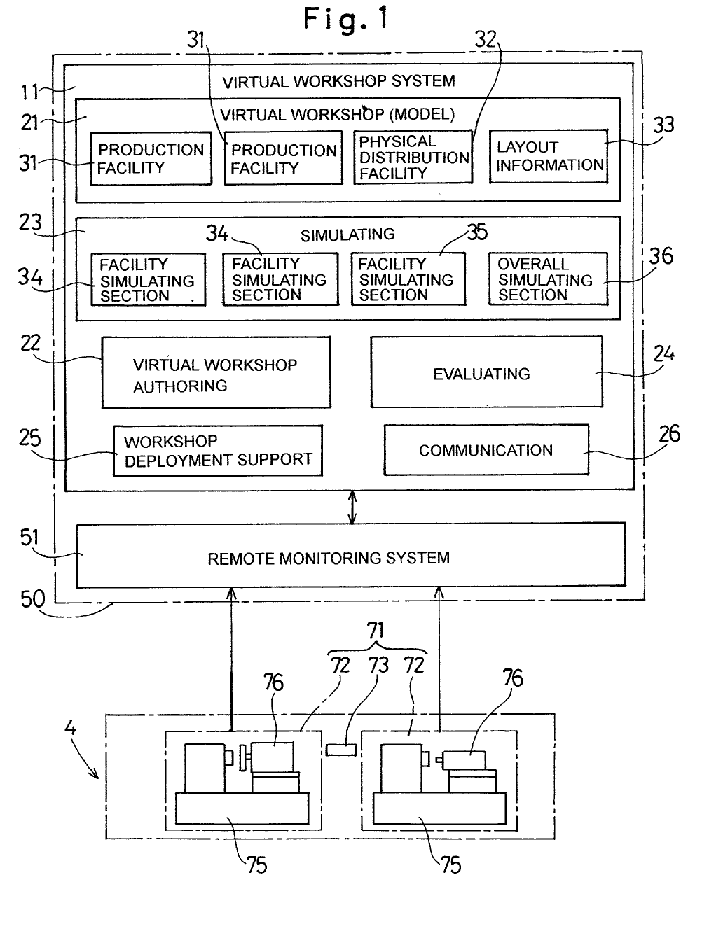

Preferred embodiments of the present invention will now be described. With particular reference to FIG. 1, a virtual workshop system 11 will first be described. The virtual workshop system 11 is operable to verify the productivity by performing simulation at the time of a new set-up and/or modification of a production line and/or reconfiguration of the existing production line. This virtual workshop system 11 cooperated with a remote monitoring system 51 to define a design and operation support system 50.

The virtual workshop system 11 includes a virtual workshop authoring means 22 for authoring a virtual workshop 21 that is a data model of a workshop 4, and a simulation means 23 for causing the authored virtual workshop 21 to perform a quasi-production activity so that at least a productive situation and a physical distribution situation can be verified. The virtual workshop system 11 also includes an evaluating means 24, a workshop deployment support means 25 and a communication means 26.

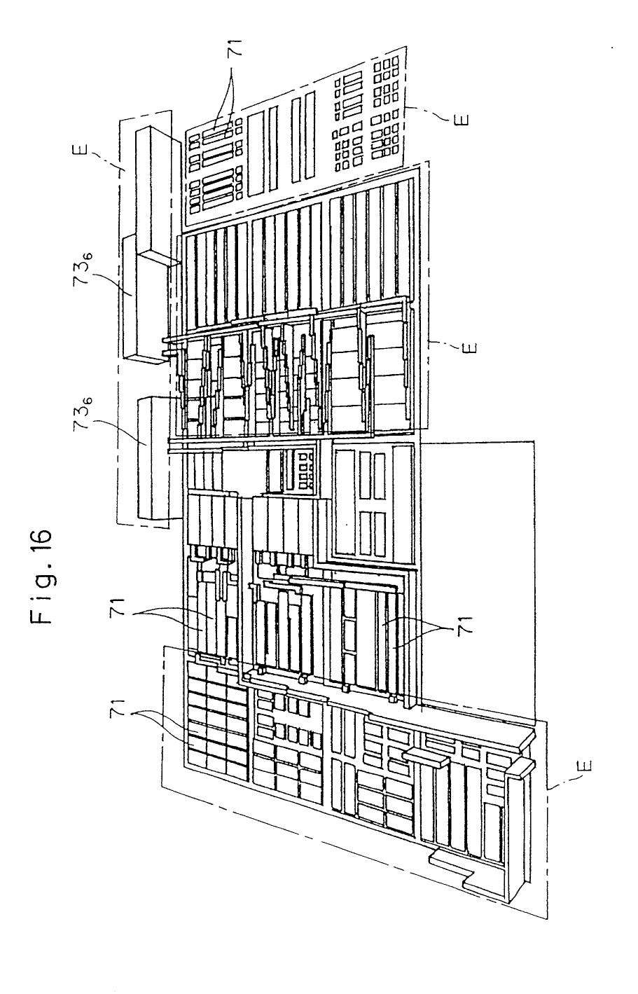

The data modeled virtual workshop 21 may be based on either a workshop 4 comprised of a single production line 71, or a workshop 4 comprised of a plurality of production lines 71. By way of example, where the workshop 4 is comprised of a plurality of production lines 71 as shown in FIG. 16, the workshop 4 may be divided into a plurality of areas E each assigned to the respective virtual workshop 21.

The virtual workshop 21 represents a model made up of respective functions of production and physical distribution facilities 72 and 73 of the workshop 4 and layout information of those facilities 72 and 73. The production facility 72 is intended to encompass facilities necessary to manufacture products and includes machine tools, plate pressing machines, assembling machines, inspecting machines, heat treatment equipment and so on. The physical distribution facilities 73 is intended to encompass facilities necessary to transport and/or deliver products within the workshop and facilities for storage thereof This physical distribution facilities 73 are available in two types: those defining the production line 71 in cooperation with the production facilities 72 and those out of the production line 71. The physical distribution facilities 73 includes a transport apparatus such as a conveyor for transporting the products from one production facility 72 to another production facility 72, automatic guided vehicles for transporting products from one production line to another, manned forklifts, automatic warehouses.

The plural production facilities 72 of the workshop 4 are designed to provide a dedicated unitary equipment in which one of modular units 76 is combined with a common process machine 75 so replaceably that process steps of the production line 71 can be modified. The details of the dedicated unitary equipment and change of the process steps will be described in detail later.

The virtual workshop is made up of virtual facilities 31 and 32 that are data models of the production facilities and the physical distribution facilities within the workshop, and layout information 33 of those facilities.

The virtual facilities 31 and 32 has data descriptive of functions of relates actual equipments, planning conditions that can be set to the actual equipments and data descriptive of running conditions. The running conditions preferably include data descriptive of types of parameters that can be set and ranges of setting, provided that they can be set to the actual equipments in the form of the parameters. The virtual facilities 31 have data representative of function of control boards of the actual equipments and, where the actual equipments are numerically controlled by an operating program, includes such operating program. Of the virtual facilities 31 and 32, the virtual facilities 31 associated with the production facilities have information on processing conditions as running conditions. The virtual facilities 31 and 32 also have data on the shape of the actual equipments. The data on the shape are those that are displayed on a display screen of, for example, a display means.

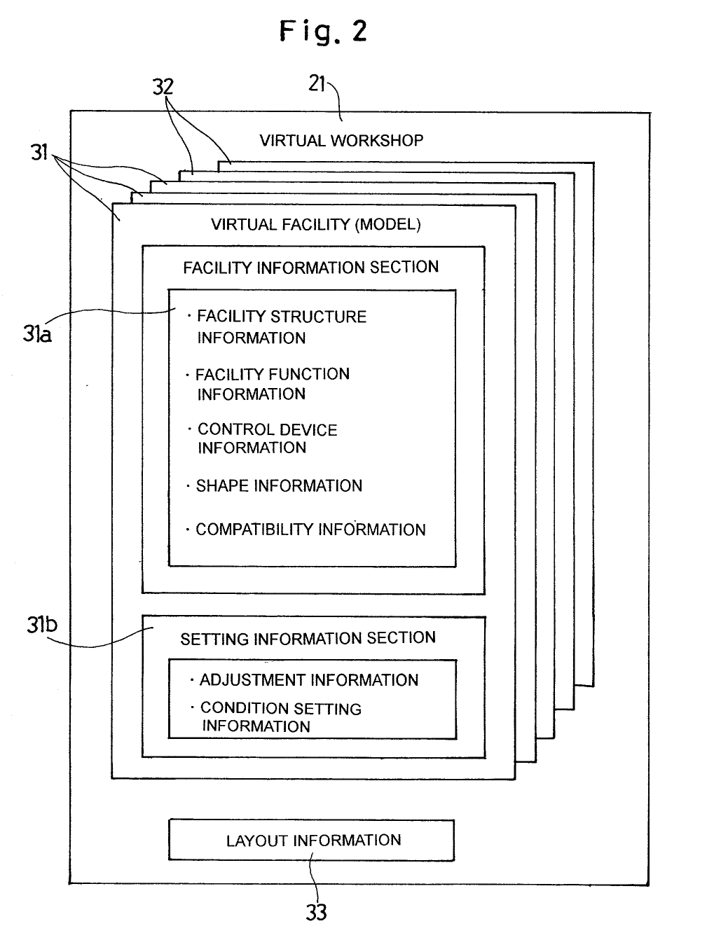

FIG. 2 illustrates a specific example of the virtual facility 31. This virtual facility 31 has a facility information portion 31a which is a group of pieces of information on the facility itself, and a preset information portion 31b which is a group of pieces of information set to the facility. The facility information portion 31a includes facility structure information related to the structure of the facility, a facility function information related to functions of the facility, control device information which is information related to control devices of the facility and configuration information related to the configuration of the facility, optionally with or without compatibility information which is information associated with compatible components of the facility if necessary. The preset information portion 31b is provided with adjustment information which is information necessary to adjust installation of the facility and also to perform adjustment of other various portions, and condition setting information which is information on conditions associated with setting of a body of the facility itself or the control devices of the facility.

Referring to FIG. 1, the simulating means 23 has a function of simulating the production state on a layout when the virtual workshop 21 is caused to implement a quasi production activity and the physical distribution state resulting from such production activity. This simulating means 23 includes facility simulating portions 34 and 35 for simulating the virtual facilities 31 and 32, respectively, and an overall simulating portion 36 for matching results of verifications performed by the individual facility simulating portions 34 and 35 to thereby apply it to the layout.

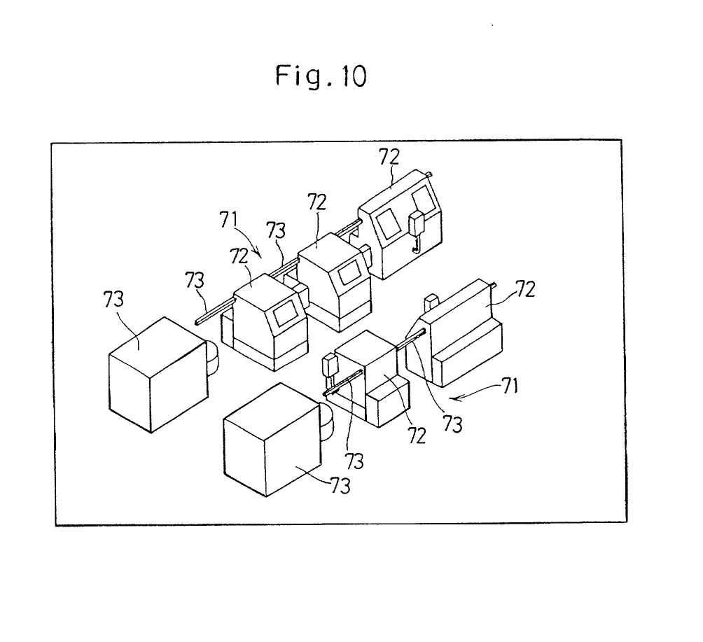

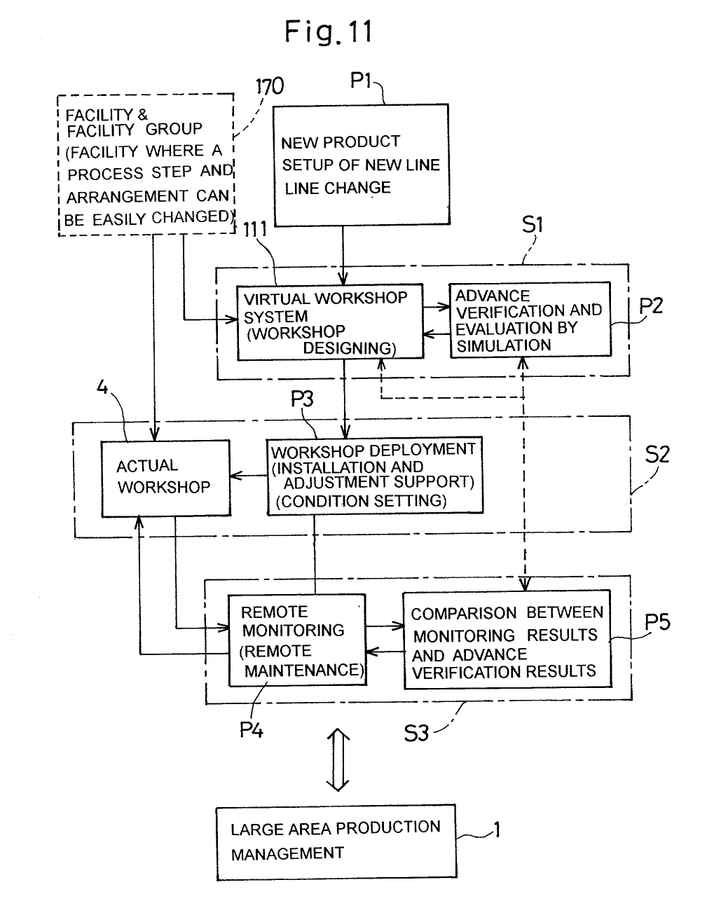

The simulating means 23 has a function of displaying results of the quasi-production activities on a layout diagram and a display portion for indicating a state of physical distribution in various parts on the layout diagram. The layout diagram is preferably displayed in the form of a three-dimensional model. The display portion capable of indicating the physical distribution of goods may be of a type capable of presenting, for example, a diagram in which works are stacked at various positions on the layout diagram to thereby display the amount of the works in terms of the number of stacking of the works, or presenting a graph such as bar graphs at the various positions. The simulating means 23 is preferably capable of displaying, on an enlarged scale, small portions in the hierarchical order over the facility or the structural portions of the facility. Even the diagram of each of the facilities is preferably capable of being presented in a three-dimensional model. An example of a display appearing on the display screen of the overall layout of the virtual workshop 21 by the simulating means 23 and an example of a display appearing on the display screen of the production system made up of the plural adjoining production lines are shown in FIGS. 9 and 10, respectively. In these figures, the images displayed are referenced by the same reference numerals as those applied to the actual facilities.

Referring to FIG. 1, the virtual workshop authoring means 22 is a means for formulating the virtual workshop 21 of the data model capable of being simulated by the simulating means 23, based on the data associated with the facilities stored in a facility database.

The evaluating means 24 is a means for performing a predetermined evaluation relative to results of the simulation, for example, for evaluating the cost, the productivity and the workability of attendant workers. The workshop deployment support means 25 is a means for providing an assistance to facilitate utilization of information obtained from the virtual workshop system 11 when the workshop is to be developed.

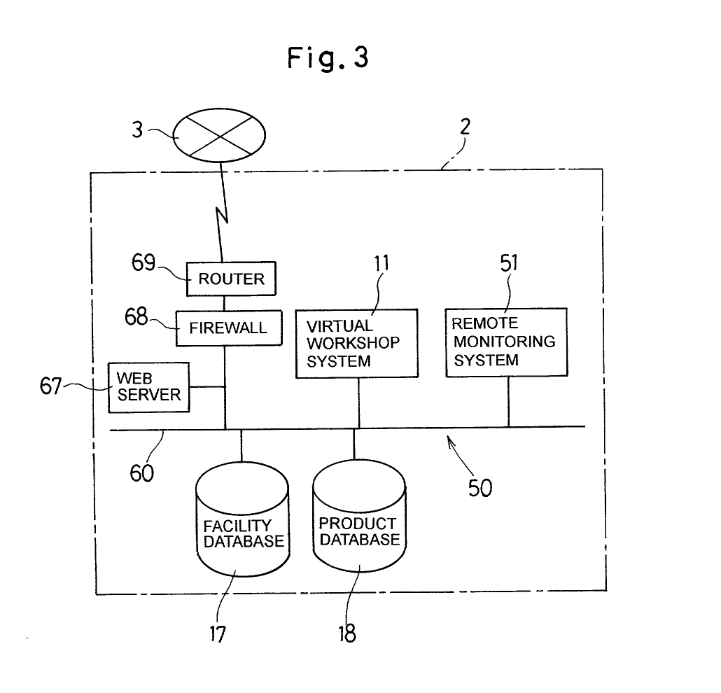

FIG. 3 illustrates an example of a hardware architecture of the design and operation support system 50 of the workshop facility including the virtual workshop system 11. A local area network 60 within a business establishment 2 is connected with a computer forming each of the virtual workshop system 11 and the remote monitoring system 51 and a computer forming a facility database 17 and a product database 18. Although in FIG. 3 the virtual workshop system 11 and the remote monitoring system 51 are represented by single unit, respectively, these systems 11 and 51 may be implemented having been dispersed to a plurality of computers. Also, each of the databases 17 and 18 may be a single database which can be recognized as a logically single integer or may be comprised of a plurality of physically separate databases. The local area network 60 is connected with a communication network 3, which is one of communication interfacing means for interfacing with outsides of the business establishment 2 through a firewall 68 and a router 69 or the like, communication of which is supervised by a web server 67.

The facility database 17 referred to above is a means in which information on the various production facilities and the physical distribution facilities are registered and, in addition to the information on the facilities themselves, information on accessory components such as, for example, jigs and tools are registered as well. The facility database 17 may have additionally registered therein a processing programs of the production facilities. The product database 18 is a means in which model numbers, shapes, processing orders, materials, functions, precisions of the various products are registered.

The remote monitoring system 51 referred to above is a means for remote monitoring at least the production state and the physical distribution state on the layout of the facilities 72 and 73 of the actual workshop 4 (FIG. 1). The production state and the physical distribution state include goods in process and inventories of the complete products. As the production state referred to above, the productivity and the past production record can be monitored. This past production record may include, in addition to the past production record of the products, the past production record of the goods in process, the state of arrival of component parts, working states of the various facilities and the state of progress of the production plan. This remote monitoring system may have a function of comparing results of monitoring obtained by the remote monitoring with results of verification upon simulation where the actual workshop 4 is constructed faithfully after the virtual workshop 21. This comparing function may be provided in the virtual workshop system 11, instead of the remote monitoring system 51, or in both of the systems 51 and 11, or may be provided in a different system separate from these systems 51 and 11.

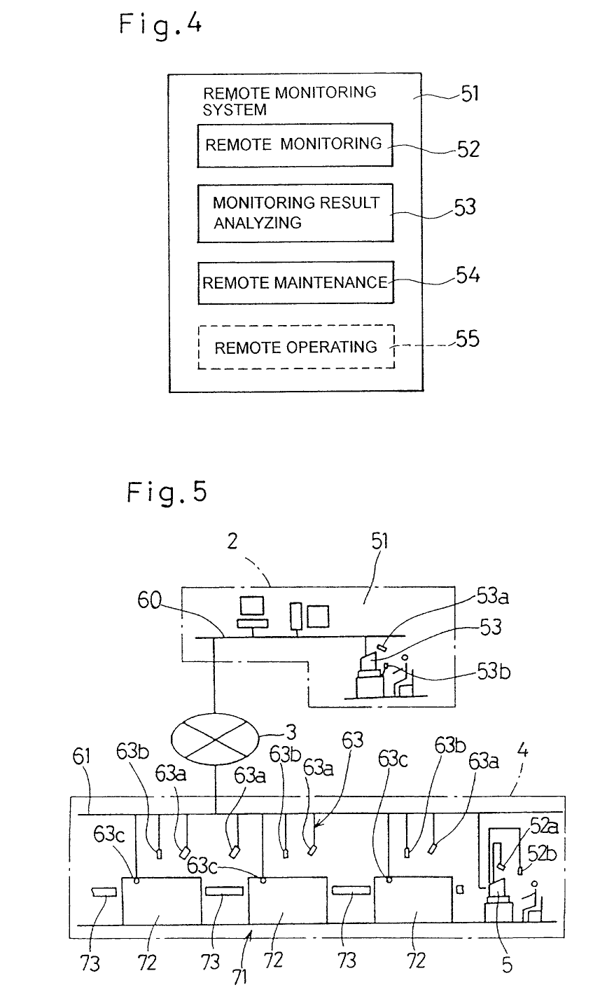

As shown in FIG. 4, the remote monitoring system 51 includes a remote monitoring means 52, a monitoring result analyzing means 53 and a remote maintenance means 54. The remote monitoring system 51 may further include a remote operating means 55. The monitoring result analyzing means 53 is operable to analyze, for example, information obtained by monitoring and then to output a countermeasure such as condition changing data. An analyzing result output of this monitoring result analyzing means 53 is inputted to, for example, the remote maintenance means 54 so that automatic remote maintenance can be performed through the remote maintenance means 54, or the analyzing result output referred to above may be presented to a technician as support information for remote maintenance.

FIG. 5 illustrates a concept of monitoring performed by the remote monitoring system 51. This remote monitoring system 51 is of a type capable of performing monitoring and remote maintenance by means of images, voices, mechanically generated signals and others. Monitoring sensors 63 are provided to the various production facilities 72 and the physical distribution facilities 73 within the workshop 4 to be monitored. The monitoring sensors 63 may include, for example, monitoring cameras 63a, microphones 63b and intra-facility sensors 63c. The monitoring cameras 63a is for imaging the working state of the production facilities 72 and for imaging the flow of materials and products within the physical distribution facilities 73, respectively. The microphones 63b is for recording sounds in the environment of the production facilities 72 and the physical distribution facilities 73 and sounds generated by the facilities. The intra-facility sensors 63c are provided in the various facilities 72 and 73 to detect respective states within the facilities and may be employed in the form of sensors used for control of those facilities. The intra-facility sensors 63c include, for example, a rotational speed detecting means of motors, an ammeter, a limit switch, a temperature sensor, a vibration sensor, a microphone or the like. Although in FIG. 5 only one intra-facility sensor 63c is shown as installed in the facility 72, a plurality of intra-facility sensors 63c are generally employed in practice. These monitoring sensors 63 are connected with the communication network 3 outside the workshop through the local area network 61 within the workshop 4 and in turn connected with the local area network 60 within the business establishment 2 where the remote monitoring system 51 is installed.

The remote monitoring system 51 is of a type cable of achieving an interactive remote monitoring and remote maintenance using an interactive terminal 52 on the side of the workshop 4 that is operated by an operator and an interactive terminal 53 on the side of monitoring. These interactive terminals 52 and 53 may be an independent computer or that mounted on a control panel and includes cameras 52a and 53a for imaging an operator and microphones 52b and 53b for transmitting voices generated by the operator.

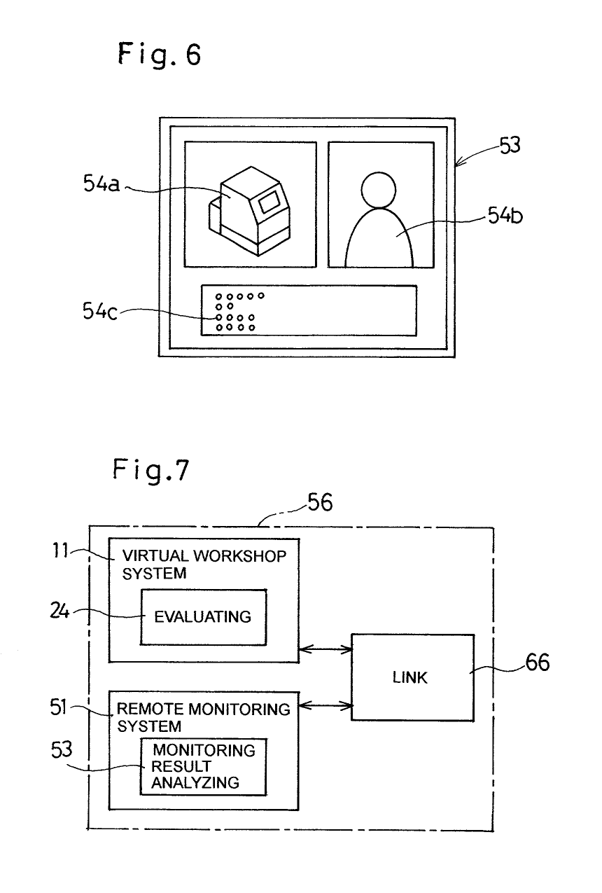

FIG. 6 illustrates an example of a display screen of a display device used in the interactive terminal 53 on the monitoring side, which displays an image 54a of the facility to be monitored, an image 54b of the operator in the workshop and character information 54c in a predetermined layout. The character information 54c represents data on the facility that are necessary for monitoring or remote maintenance. The display portions of those images 54a and 54b and character information 54c may be separated by respective windows or by frames within the same window. The workshop side interactive terminal 52 is, as is the case with the monitoring side interactive terminal 53, capable of displaying an image of the facility to be monitored, an image of the operator on the monitoring side and character information in a predetermined layout.

As shown in FIG. 7, the virtual workshop system 11 and the remote monitoring system 51 are linked together by means of a link means 66, and the virtual workshop system 11 and the remote monitoring system 51 cooperate with the link means 66 to define a virtual workshop-remote monitoring link system 56.

The link means 66 is operable to compare the result of verification based on simulation performed by the virtual workshop system 11 and the result of remote monitoring performed by the remote monitoring system 51. This link means 66 may be a part of the remote monitoring system 51 or a part of the virtual workshop system 11. Comparison between the verification result and the remote monitoring result may not be a direct comparison, but may be a comparison between the result of evaluation of the verification result and the result of analysis obtained by analyzing the remote monitoring result. Also, the link means 66 is so designed as to determine the difference resulting from the above described comparison and then to perform a function of executing a predetermined process dependent on the difference determined from the result of comparison. The link means 66 may be of a type capable of unifying screen contents of the display device at the time of simulation performed by the virtual workshop system 11 and screen contents of the display device at the time of remote monitoring performed by the remote monitoring system 51. An example of an unified image displayed will now be described in connection with detailed examples of the virtual workshop system 11 and the remote monitoring system 51.

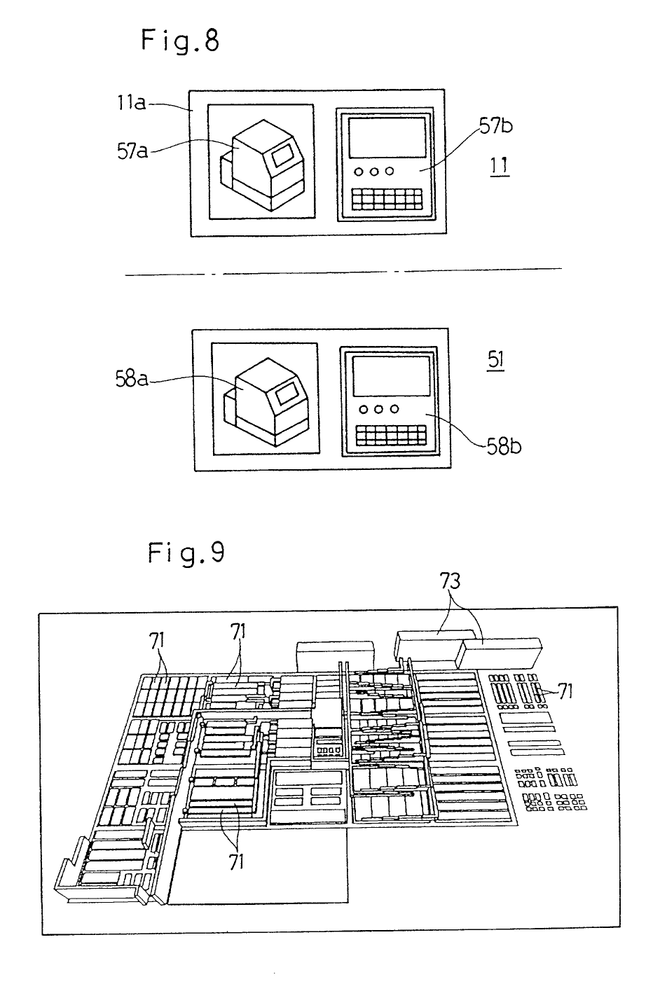

As shown in FIG. 8, the virtual workshop system 11 is capable of displaying on a screen of a display device 11a, a model image 57a of the facility during simulation, and a model image 57b of an operating panel of a control device of such facility. The virtual workshop system 11 is so designed that by specifying the model image 57b of the operating panel by means of a pointing device such as, for example, a mouse, setting of conditions corresponding to an actual operating panel and operation of the virtual facility during the simulation can be carried out.

The remote monitoring system 51 is capable of displaying a facility image 58a of a modeled facility or an actual facility, and an image 58b of a modeled operating panel or an actual operating panel of such facility. Also, the remote monitoring system 51 is so designed that by specifying the image 58b of the operating panel by means of a pointing device, setting of conditions corresponding to the actual operating panel and operation to run the facility can be carried out.

Thus, matching between the screens of the remote monitoring system 51 and the virtual workshop system 11 is carried out by the link means 66 (FIG. 7). Where the remote monitoring system 51 provides model images of the facility and the operating panel, not the videoed images thereof, the link means 66 can consolidate such image with the image in the virtual workshop system 11. Also, the link means 66 may be so designed as to display on the same display device or an adjoining display device, a simulation screen in the virtual workshop system 11 and a monitoring screen in the remote monitoring system 51.

With particular reference to FIG. 11, a method of designing and working the workshop facilities will now be described. This method is to perform a new set-up of a production line of an actual workshop 4 and line change (step P1) incident to development of new products and convenience of a production planning while there is a facility and a group of facilities 170, and then to operate such actual workshop. The facility and the group of the facilities 170 may be those already installed in the actual workshop, or stored or in process of being designed. Of these facilities, a portion of the production facilities or the whole production facilities are rendered to be the dedicated unitary equipment which has been described with reference to FIG. 1.

The method of designing and operating the workshop facilities includes a virtual workshop verification process (S1), a workshop deployment process (S2) and a remote monitoring process (S3). This method of designing and operating the workshop facilities is applied to a wide area workshop production management system.

During the virtual workshop verification process (S1), functions of each production facility 72 and physical distribution facility 73 of the workshop 4 shown in FIG. 1, a portion or the whole of which has been newly designed, and the virtual workshop 21 which is a model constructed based on layout information 33 on these facilities are generated. In this virtual workshop 21, a quasi-production activity is caused to occur by the simulating means 23 (step P2) so that the various states on the above described layout can be verified.

While the simulation of the above described quasi-production activity is preferably such as to enable verification as close to the actual workshop 4 as possible, simulation is possible of the production state and the physical distribution state of the facilities 72 and 73 in the layout of the layout information. Results of the simulation are displayed so that on the entire layout of the workshops 4 shown in FIGS. 9 and 10 or a three-dimensional model of the production line 71 of a portion of the workshop 4, the amount of the works that are material and products produced and the status of flow can be observed in the form of diagrams, symbols, characters, numerals and so on. By simulating the production state and the physical distribution state on the particular layout, it is possible to locate a site of the production line 71 where efficiency is low and then to improve such site to thereby increase the overall efficiency of the production line 71 as a whole.

Also, simulation of the quasi-production activity is such as to set adjusting and operating conditions of the various facilities 72 and 73 and then to perform the quasi-production activity according to the conditions so set up. By way of example, the quasi-production activity is caused to take place by making preparation and setting control parameters and operating tact. Where the production facility is a program controlled by a control device of an NC apparatus, it is preferred that the quasi-production activity is performed according to an operating program such as, for example, an actual processing program. The speed of execution of the operating program for simulation may be higher than that for actual production. An entire simulation portion 36 in the simulating means 23 shown in FIG. 1 may, when a delay occurs in a portion of the production line 71 and this delay may affect the subsequent step, reflects the influence on the result of simulation.

Pre-verification performed by the simulation is preferably such as to verify not only the production state of the works and the physical distribution on the production line 71 as the specific layout, but also transportation of goods in process between the production lines and within the workshop and working states of personnel.

Also, pre-verification performed by the simulation is preferably such as to verify a relationship between the quality of the products produced and the set condition, a relationship between the productivity and the set conditions, and an interrelationship among the quality, the productivity and the set conditions.

Thus, by the pre-verification performed by the simulation, verification of the production state and the physical distribution state on the particular layout, verification of washout of a necking step, a processing method, processing steps, optimization of processing conditions, verification of physical distribution, evaluation of the stock inventory and efficiency of manpower, evaluation of the productivity and calculation of the manufacturing cost are carried out.

During the virtual workshop verification process (S1) shown in FIG. 11, if the contents 111 that is designed at a workshop cannot be satisfactory, verification is carried out by changing the various setting conditions and, if required, changing the process of the production line 71 (Step P2). In the event that the production line 71 has a process step that can be changed by changing the form of the production facility 72, verification of change in process step of the production line 71 is such as appropriate to the change in form. By way of example, if the production facility 72 is a dedicated unitary equipment, verification is carried out of the case in which the process step has been changed by replacement of the modular unit 76.

During the virtual workshop verification process (S1), verification according to a working calendar condition and verification according to abnormality of the facility are also preferred. The working calendar condition includes a condition of holidays of each year, a work start time of each day, a work closing time of each day, and a condition such as a lunch time and an interim time.

During the workshop deployment process (S2), the facilities 72 and 73 matching with the virtual workshop 21 that has been verified in the manner described above and the actual workshop 4 of the layout are constructed (Step P3). Setting contents of the facilities 72 and 73 are also matched with those during the simulation.

During the workshop deployment process (S2), information on operating condition set during the virtual workshop verification process (S1) may be set by transmission through the data communicating means to the control device of the production facility 72. Conditions for installation of the facilities 72 and 73 obtained during the virtual workshop verification process (S1), when instructed to an information processing device positioned adjacent the facilities 72 and 73 of the actual workshop 4 and/or a portable information processing device so that it can be displayed in the form of diagrams and characters are such as to facilitate installation easily.

During the remote monitoring process (S3), various remote monitoring of an actual workshop 4 constructed through the above described virtual workshop verification process (S1) and the workshop deployment process (S2) is carried out. By way of example, the production state and the physical distribution state of the facilities 72 and 73 arranged according to a particular layout are remote monitored (Step P4), and results of the monitoring and the result of verification performed by the simulation are compared (Step P5). Also, the working condition of the various facilities 72 and 73 and the quality or the like of the works so produced are also remote monitored. During this remote monitoring process (S3), remote maintenance of the facilities 72 and 73 is preferably carried out by the utilization of the result of the monitoring and the facilities 72 and 73 may be operated by a remote control. Maintenance by the remote control includes change in operating condition, processing condition and parameter to be performed by the remote control and a process of instructing such change to an information processing equipment installed at the workshop 4.

During the remote monitoring process (S3), where there is a difference between the monitoring-result and the result of verification performed during the simulation, the virtual workshop 21 is instructed by the simulating means 23 to re-perform a quasi-production activity for verification purpose and the facilities 72 and 73 of the actual workshop 4 may be maintained by the remote control depending on the result of such verification. The quasi-production activity that is re-performed may be carried out under setting conditions or the like that are different from those at the time of deployment of the workshop may be employed.

An example of a setting condition and contents to be monitored will now be described on the assumption that target products produced in the workshop 4 utilizing the remote monitoring system 51 and the virtual workshop system 11 are mechanical components having rolling elements, for example, rolling bearings or constant speed joints, and one of the production facilities 72 is a grinding machine.

In the case of such grinding machine, as an operating condition or a processing condition, the number of revolutions of a tool, a tool feed speed, a tool feed quantity, a dress condition, the number of revolution of a main shaft and other are set. Also, as a condition of the article to be processed, the name of the product, the weight, a groove grinding width, a specific heat, a coefficient of thermal expansion, dimensional preciseness of various parts and others are set. Also, as information necessary to comprehend the processing condition, a processing power, the size of the product being processed, the processing temperature, the processing time and others are set. The remote monitoring are performed subject to those conditions.

By remote monitoring those conditions, and making it possible to change the settings by means of the remote control, maintenance by the remote control is possible with respect to various inconveniences.

As discussed above, by using the virtual workshop system 11, verification of the workshop as a whole can be performed easily. For this reason, deployment of the workshop such as a new setup of the production line, change in process steps of the existing line and others can be performed efficiently in a short time, and the necessity of performing a rerun subsequent to the deployment of the workshop can be eliminated. In particular, where verification to be performed where as the production facility 72, a production facility having a large freedom of change such as the dedicated unitary equipment is employed and the process step of the production line is changed is desired to be performed by the virtual workshop system 11, the length of time required for deployment for the workshop deployment can be considerably shortened. Also, since the actual workshop 4 matching with the virtual workshop system 11 that has been verified by the simulation is constructed and by remote monitoring such actual workshop comparison is made between the result of remote monitoring and the result of verification of the simulation, the result of the simulation can effectively be used for the remote monitoring to achieve a proper remote monitoring of the constructed workshop 4. By way of example, where there is a difference between the result of the remote monitoring and the result of simulation, re-simulation in which the setting conditions and others of the virtual workshop 21 have been changed is carried out so that a proper maintenance can be achieved. During the remote monitoring by the remote monitoring system 51, by allowing it to have a remote maintenance function, proper maintenance can be quickly performed from the result of monitoring by the utilization of a skilled technician and a highly precise analyzing instruments at a remote site. Accordingly, the production technical power of each of the workshops 4 can be increased.

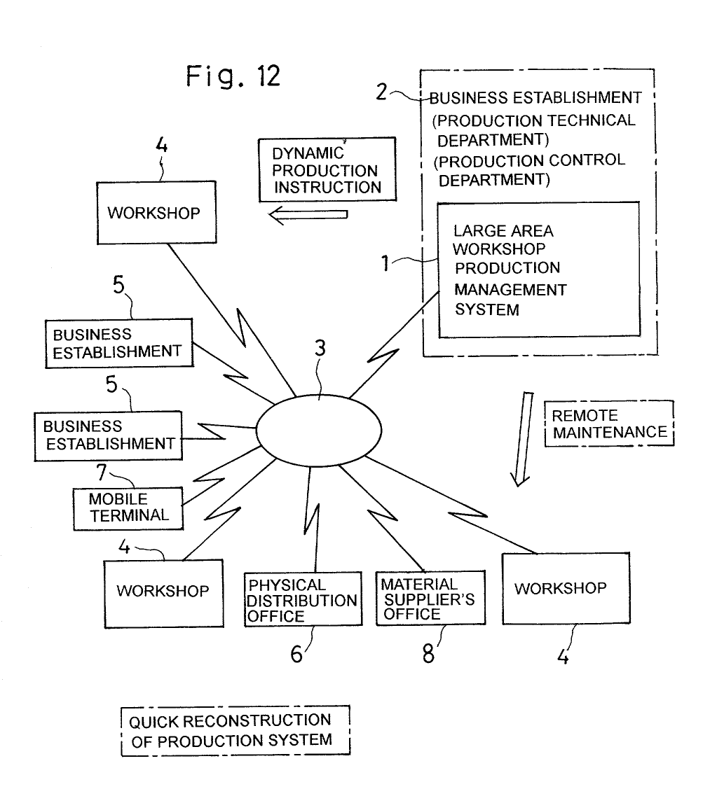

Hereinafter, a large area workshop production management system 1 utilizing the virtual workshop system will be described with reference to FIGS. 12 to 15. This large area workshop production management system 1 is intended to perform a production management and a production technique support on a collective basis with respect to workshops 4 that provide production bases in various countries all over the world. This large area workshop production management system 1 is a production management system utilizing the virtual workshop system and is installed at business establishments 2 including a production technique department, a production supervising department and others in which production management and technique management are collectively performed. The large area workshop production management system 1 is linked through a communication network 3 with the business establishments such as workshops 4, business offices 5 and others at various sites and also with physical distributing offices 6, mobile terminals 7 which are a information terminal handled by an individual, and material supplier offices 8 which are a parts manufacturers and others. The workshops 4 at various sites are those installed in various countries of the world.

The communication network 3 may be an Internet, a dedicated communication network or a VPN (Virtual Private Network). The communication network 3 is employed in the form of an Internet VPN or the like in which, for example, after security has been established communication is made to a local area network at each of the business establishments through the Internet.

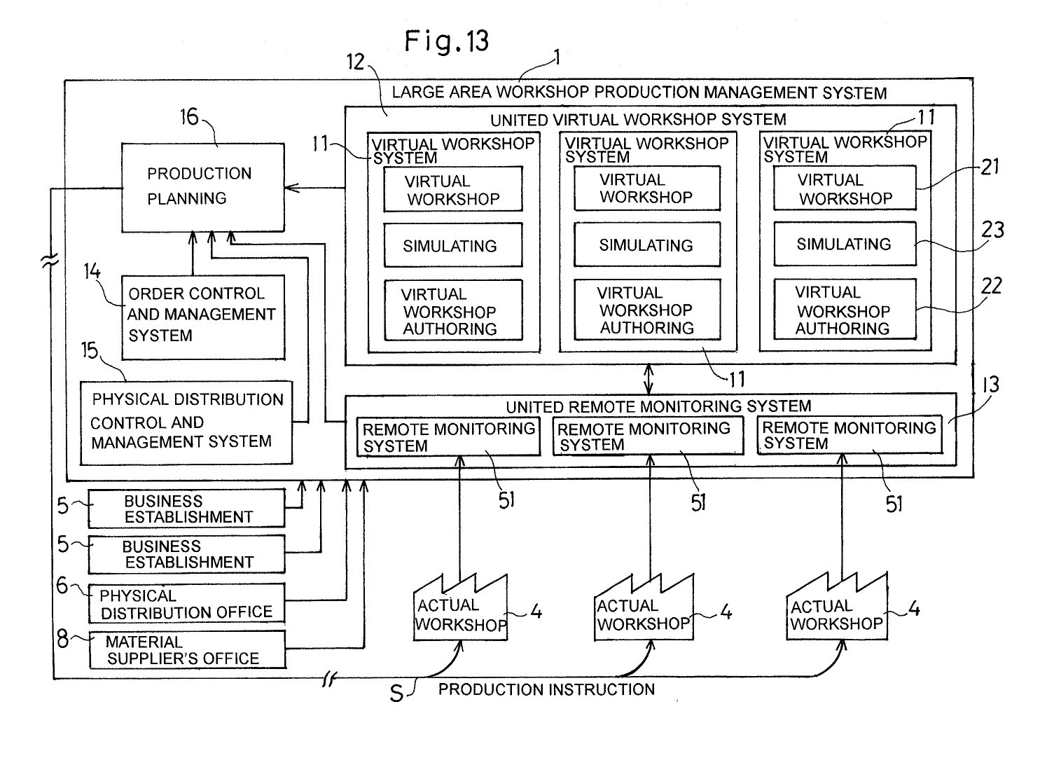

As shown in FIG. 13, the large area workshop production management system 1 is provided with a united virtual workshop system 12 in which a plurality of virtual workshop systems 11 corresponding respectively to the actual workshops 4 at the various sites are united together. The united virtual workshop system 12 is provided with, in addition to the virtual workshop systems 11 corresponding to the actual workshops 4, virtual workshop systems 11 corresponding to workshops that are newly constructed. This large area workshop production management system 1 is provided also with a united remote monitoring system 13 for remote monitoring the actual workshops 4 at the various sites, a order controlling and management system 14 for unifying and managing order information of the various business offices 5, a physical distribution controlling and monitoring system 15 for controlling and monitoring physical distribution conditions at various sites, a production planning means 16 and various databases (not shown in FIG. 13). The united remote monitoring system 13 is made up of an aggregation of the remote monitoring systems 51 corresponding respectively to the actual workshops 4. The virtual workshop system 11 and the remote monitoring system 51 are those structured and described with reference to FIGS. 1 to 11. It is to be noted that the united virtual workshop system 12 and the united remote monitoring system 13 may be of a design wherein structural components of the virtual workshop system 11 and structural components of the remote monitoring system 51 are concurrently utilized as a result of unification.

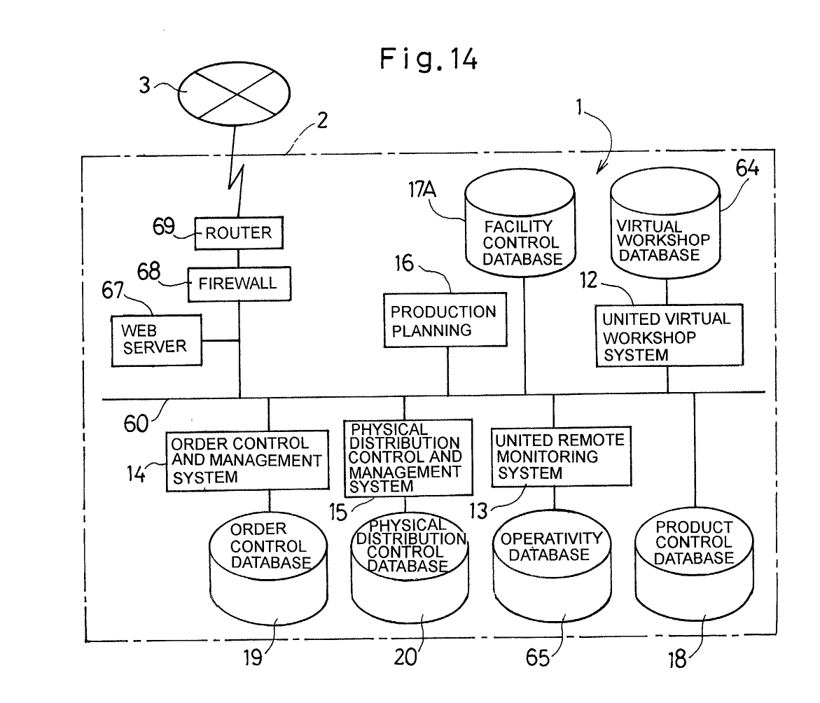

FIG. 14 illustrates an example of a hardware configuration of the large area workshop production management system 1. The large area workshop production management system 1 is of a design in which the design and operation support systems of the workshop facilities shown in FIG. 1 are united together and developed. Each of computers in a local area network is provided with the united virtual workshop system 12, the united remote monitoring system 13, the order controlling and management system 14, the physical distribution control and management system and the production planning means 16. Also, the local area network 60 is connected with various databases, for example, a facility controlling database 17A, a product controlling database 18, an order controlling database 19, a physical distribution database 20, and a virtual workshop database 64.

The order controlling and management system 14 represents a means for collectively unifying and managing order information at the business offices 5 which are a business establishment associated with orders. The business offices 5 are those located in various countries all over the world, regardless of their size. The business offices 5 may be a terminal of an individual or a large scale business office where order information from a plurality of business offices are collected.

The order information managed by the order controlling and management system 14 includes types of products, amount, delivery price, date of delivery, place of delivery, information on compatibility, special consideration and others. The order information are registered in the order collecting database 19 and managed by the order controlling and management system 14.

The physical distribution control and management system 15 is a system for controlling and managing, as physical distribution information, information associated with place of delivery of the products of each workshop 4, transportation and storage from or to sources of component parts and materials available. The physical distribution control and management system 15 also collectively manages, as the physical distribution information, stock of products in process, and stocks of component parts and materials. The physical distribution information are registered in the physical distribution database 20 and managed by the physical distribution control and management system 15. If each of the products is labeled with an identification code, it is possible to quickly find what is where in what quantity.

The product controlling database 18 is a database in which various information on products that can be produced at each workshop 4, for example, the type of products, number of the products, the size, the performance, the accuracy, material necessitated to make such products, the processing method, processing portions and others are registered.

The facility controlling database 17A stores therein information of facilities in the actual workshop 4 that is a target of the production planning, information on the set-up of such facilities, operating programs of such facilities, peculiar information (a so-called “habits”) on such facilities and others. By way of example, the facility controlling database 17A has stored therein information on the type, performance, dimension, planning change and others all associated with facilities installed already at the workshops 4, and layout information for each workshop of the facility so installed or for each production line. If the facility has a morphology that can be changed such as by changing a modular unit 76 (FIG. 1), the facility controlling database 17A may also store therein information associated with the morphology to which it can be changed. The facility controlling database 17A also stores, even though it is not actually installed at any workshop 4, information associated with the facilities which would be scheduled to be installed.

The virtual workshop database 64 is a database in which information on each of virtual workshops 21, which is a data model formed by the united virtual workshop system 12, is registered together with information on their settings.

The united remote monitoring system 12 is adapted to acquire information on the production record, the state of the product being in process, the state of component parts delivered, the state of stock and the operating state of the actual workshop 4. Also, workshop data collected by the united remote monitoring system 12 are accumulated in an operating state database 65 in the form as collected or after having been data processed. Each of the remote monitoring systems 51 of the united remote monitoring system 12 preferably has a previously described remote monitoring function and remote maintenance function. Each of the remote monitoring systems 51 (FIG. 13) of the united remote monitoring system 13 if it has the above described functions is effective to perform a collective management of monitoring and maintaining the workshops.

The production planning means 16 is a means operable in response to information supplied from the united remote monitoring system 13, the order controlling and management system 14 and the physical distribution control and management system 15 to initiate verification by the united virtual workshop system 12 and then to automatically formulate a production plan to be shared to the actual workshops 4 depending on the result of verification.

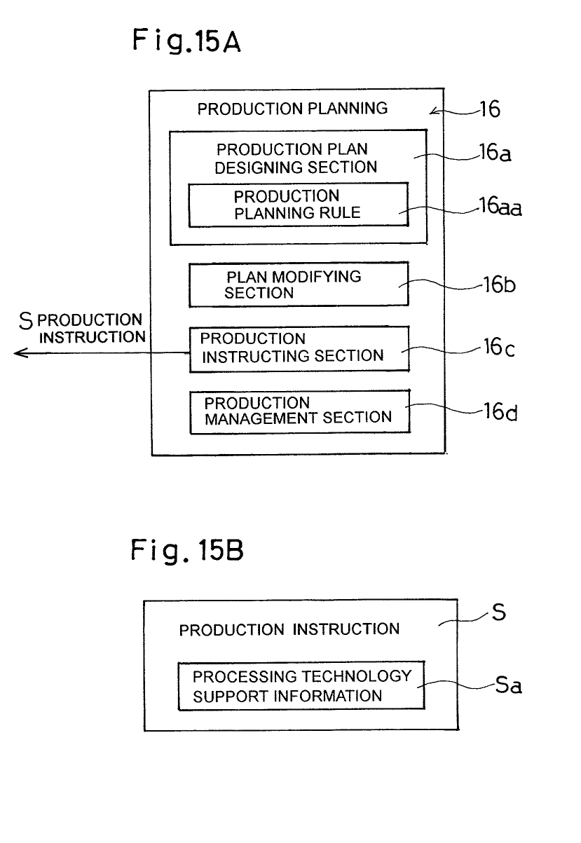

The production planning means 16 includes, as shown in FIG. 15A, a production planning section 16a, a plan modifying section 16b, a production instructing section 16c and a production management section 16d.

The production planning section 16a is a means operable in response to information, supplied from the united remote monitoring system 13, the order controlling and management system 14 and the physical distribution controlling and management system 15, to cause the united virtual workshop system 12 to initiate verification and then to automatically formulate a production plan according to a predefined production planning rule 16aa. The production planning is a production planning that is distributed to each of the workshops 4. The production planning rule 16aa is such as items including a production capability, a physical distribution, materials, tax and others, which are weighted in the order of importance and which can be selected in a specific order.

The production planning section 16a determines if each of the actual workshops 4 has its process step capable of being changed according to a predetermined standard and, in the event that the process step can be changed, causes the united virtual workshop system 12 to initiate verification of the production state when the various process steps are changed, before the production plan is planned according to the above described production planning rule 16aa. Also, the production planning section 16a can cause the united virtual workshop system 12 to initiate various verifications of the predetermined operations, such as arrangement of jigs and tools of the various facilities, change of the setting condition, change of the operating program and others so that the production planning can be achieved according to the production planning rule 16aa.

In particular, where any one of the workshops 4 located at the various sites is equipped with a production facility 72 which is a the dedicated unitary equipment in which the modular unit 76 is interchangeably combined to the process machine 75 of a common specification and the process step can be changed by interchanging the modular unit 76, the production plan can be planned according to the verification of the production state which would be obtained when the process step is so changed.

The production planning section 16a is, where the product comprises a plurality of components, capable of planning the production plan to be distributed to the plural workshops 4 each manufacturing one of the components.

The plan modifying section 16b is a means operable to change the production plan, formulated by the production planning section 16a, according to an input given by an operator and to supply an instruction to change conditions in response to an input given by the operator to cause the production planning section 16a to reform the production plan.

The production instructing section 16c is a means for transmitting a production instruction S for each of the workshops 4 subject to the formulated and decided production plan, to such workshop 4. The production instruction S may be added with a processing technique support information Sa such as shown in FIG. 15B. In particular, in the case of a product which the workshop 4 to which the production instruction S is given manufactures for the first time, the processing technique support information Sa is added. The processing technique support information Sa includes, for example, information on processing conditions or address information indicative of storage areas in a database in which the processing conditions are registered.

The production management section 16d is a means for managing the production state with the individual workshops 4 and an aggregation of the workshops 4 taken as a whole in comparison to the production plan.

The production management section 16d may have an automatic repairing function which, in the event that as a result of monitoring performed by the united remote monitoring system 13 one of the facilities encountering with a trouble is found, an instruction to repair the production instruction S can be supplied to any workshop 4 to change the process step in the production line and/or to change procedure to operate such as the processing program of the production facilities so as to enable a delay incurred by such facility in trouble to be compensated by the other production facilities.

It is to be noted that, in the case where the automatic repair in the event of occurrence of the facility encountering with a trouble can be carried out within the same workshop 4, the united remote monitoring means 13 may have an automatic repairing function to change the process step in the production line and/or to change procedure to operate such as the processing program of the production facilities so as to enable a delay incurred by such facility in trouble to be compensated by the other production facilities.

Also, the production management section 16d may have a function of automatically adjusting the line tact of the production line 71 by monitoring the progress of production through the united remote monitoring system 13. This automatic adjusting function may be provided in the united remote monitoring system 13. By way of example, each of the workshops 4 may have its own line tact adjusting function by providing the remote monitoring systems 51 with the above described automatic adjusting function of the line tact.

With the large area workshop production management system 1 of the construction described hereinabove, a production system having a large freedom can be obtained by managing the world in a unified fashion. In other words, it is possible to reduce the cost and also to shorten the date of delivery by optimally sharing production to these workshops 4. Also, even if production is made in any of those workshops 4, a stabilized quality can be obtained.

The foregoing system construction and the effects brought about thereby will be summarized and supplemented. The following four items are fundamental.

1. Production facilities, the places of production and the morphology of which can be freely changed, to accommodate demands and production costs.

2. Planning of an optimum production system using the virtual workshop system 11.

3. Strengthening of the production technology by remote monitoring and remote maintenance.

4. Global dynamic production planning by sharing and transparent rendering of business, physical distribution and production information.

The foregoing items will now be individually specifically discussed.

(1) Flexible Production System (Employment of the Dedicated Unitary Equipment, and Resultant Compactization and Making it Intelligent

The workshops 4 which are production bases are arranged with facilities that can cope flexibly with change in type, change in process step, change in production base.

The production facilities 72 are preferably so designed as to provide compactization and low cost production.

The facility information and the quality information all over the world can be collected from a remote site by means of the networks, analyzed and compared to automatically adjust all of the facilities to the optimum conditions (states).

The facilities and the facility groups are independent and, based on the facility information and the quality information, estimation of the surface quality and the process efficiency is carried out, and feedback and feedforward can be effected to the process conditions and targeted dimensions.

In the event of a trouble or failure occurring in the facility, the other facilities therearound are automatically exchanged to compensate therefore.

(2) Evaluation and Design by the Virtual Workshop System 11 and the United Virtual Workshop System 12

Layout verification is possible using a three-dimensional model of the whole of workshops 4.

Based on the evaluation resulting from the process simulation, the processing method and steps and conditions can be optimized.

Optimization of the physical distribution is possible by examining the neck process step by means of the quasi-production activity and evaluating the stock inventory.

Maximization of the work efficiency is possible by analyzing behaviors of manpower.

Accurate productivity and manufacturing cost can be calculated by performing an overall verification.

(3) Remote Monitoring and Remote Maintenance by Means of the Remote Monitoring System 51 and the United Remote Monitoring System 13

Analysis, evaluation and modification of states of the facilities, work instruction and program change can be performed by remote monitoring the facilities, facility groups, operating states of the process, the facility information and the quality information through the network, utilizing image and/or voice transmitting devices capable of ascertaining image and sounds of the field sites, and/or receiving a technical support from a technician at the remote place.

If the remote monitoring system 51 is installed at one place or a plurality of places in the world, a 24-hour maintenance can be received.

Based on the maintenance information collected from the facilities by the remote monitoring system 51, it is possible to automatically design a maintenance plan of the workshops as a whole and also to provide it with the work instruction.

Analysis and evaluation of the facilities in the workshops 4, which are the production bases, are possible by utilizing analyzing tools and databases owned by a technical department or a company from the remote sites through the network.

(4) Worldwide Production System

By publishing business information and progresses of production (record, physical distribution) as real time information, and based on these, a production plan in which the customer's requirements and production and physical distribution costs are taken into consideration, can be automatically reconstructed and by the production planning means 16 of the large scale workshop production management system 1 and can instantaneously be shared and instructed over the territorial boundaries.

The workshops 4 automatically reconstruct the current plan into the most efficient plan with respect to change in production plan that has been instructed and then instruct to the field sites.

Information on management of the facilities and the facility groups and information for each of programs and production facilities are commonly shared by a server of the database in a unified global fashion over the world and, based on the production plan, necessary information from the database server are exchanged to change the process steps and change in type.

In the next place, specific examples of the workshops 4 and facilities 72 and 73 will be described with reference to FIGS. 16 to 24. FIG. 16 illustrates a layout of the workshop 4 in its entirety in which a plurality of production lines 71 are installed. This workshop 4 is a factory where, for example, a rolling bearing is manufactured and, as the production lines 71, there are a production line for manufacturing inner races of the bearings, a production line for manufacturing outer races, a production line for manufacturing rolling elements, a production line for manufacturing retainers or cages, a production line for assembling bearings and others, each of these productions being provided in a plural number. As one of physical distribution facilities 73, an automatic warehouse 736 is provided.

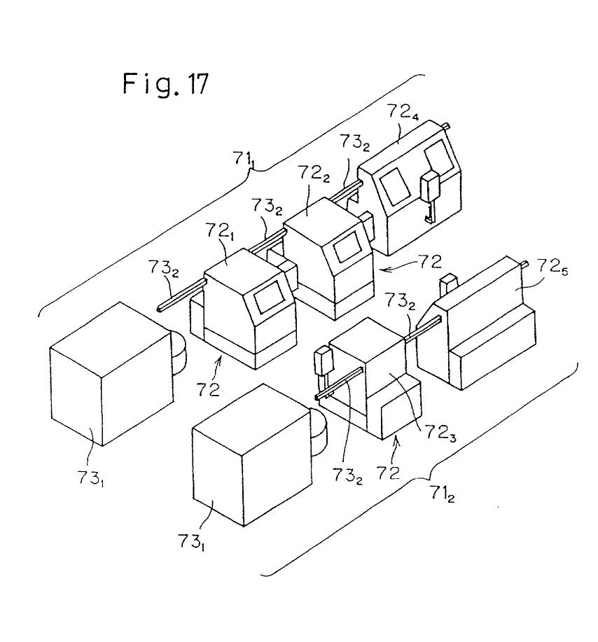

FIG. 17 illustrates some of a group of the production lines employed in the workshop 4. In this figure, a production line group in which two production lines 71 (71₁ and 71₂) are juxtaposed relative to each other. Each of these production lines 71 is made up of a plurality of production facilities 72 and a plurality of physical distribution facilities 73. For the physical distribution facilities 73, storage facilities 73₁ and transport apparatuses 73₂ are provided. The storage facility 73₁ referred to in this specification is intended to encompass a facility having a function of temporarily storing a supply device in readiness for supply or the like in combination with other functions. The storage facility 73₁ may be an automatic warehouse or others capable of storing either a small quantity or a large quantity. In the illustrated example, the storage facility 73₁ is rendered to be a facility for storing materials, products in process or works such as products and others and is juxtaposed with the production facility 72. The transport apparatuses 73₂ are an apparatus for transporting the works between the various production facilities 72 or between the production facility 72 and the storage facility 73₁. Each of the transport apparatuses 73₂ may be comprised of, for example, a conveyor, a chute or the like and is shown in the form of a linear conveyor arranged.

Each production facility 72 is a facility for manufacturing goods by means of a mechanical processing, a plasticizing process, a heat treatment or the like and is, for example, a machine tool. In the illustrated example, the production lines 71₁ and 71₂ represent production lines for manufacturing inner races and outer races of the rolling bearings, respectively. The production facilities 72₁, 72₂ and 72₄ in the first production line 71₁ represent an inner race groove grinder, an inner race inner periphery grinder and an inner race groove ultra-finishing machine, respectively, whereas the production facilities 72₃ and 72₅ in the second production line 71₂ represent an outer race groove grinder and an outer race groove ultra-finishing machine, respectively.

The production facilities 72 form respective line constituent elements of each of the production lines 71₁ and 71₂. The production facility 72 is a dedicated apparatus of a unitary structure in which modular units are interchangeably combined relative to the process machine of a common specification and, by changing the modular units of these production facilities 72, the process step can be changed. Each of the production facilities 72 may not be always required to have the process machine of the common specification among the entire production facilities 72 in the production line 71 or may have the process machine of the common specification among the plurality of the production facilities 72. Also, as a line constituent element, a production facility having no process machine of the common specification may be included.

In the illustrated example, the three production facilities 72₁ to 72₃ which serve as a grinder have a common process machine and the two production facilities 72₄ and 72₅ which serve as an ultra-finishing machine have a common process machine.

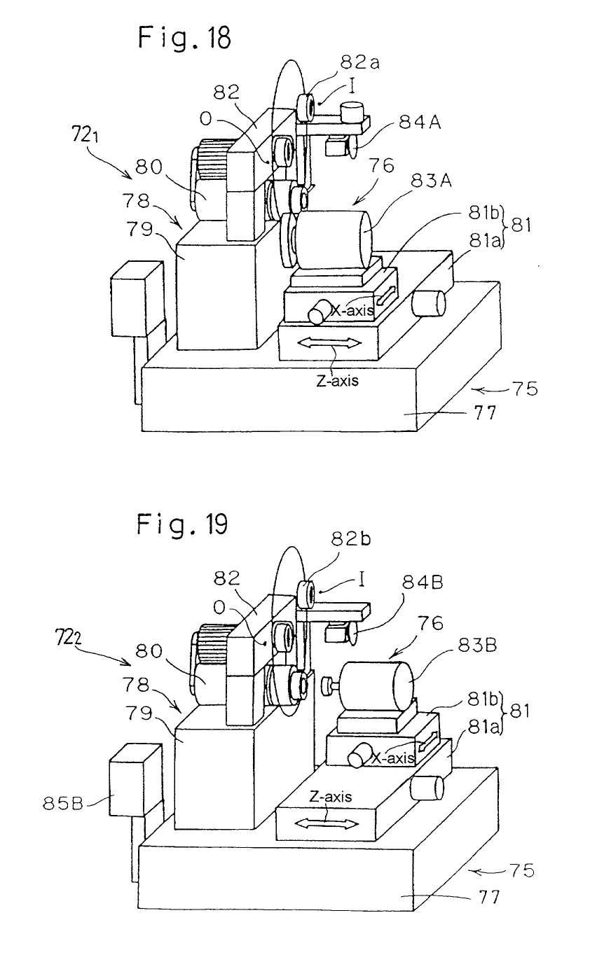

FIGS. 18 to 20 illustrate specific examples of the production facilities 72 in the form of dedicated unitary equipments having the process machine of the common specification. The production facilities 72₁ to 72₃ shown in these figures are constructed as the inner race groove grinder, the inner race inner periphery grinder and the outer race groove grinder shown in FIG. 17, respectively. FIG. 21 illustrates the process machine 75 therefor.

These production facilities 72 are a dedicated machine of an unitary structure in which modular units are interchangeably combined relative to the process machine 75 of the common specification. The common process machine 75 includes a common bed 77 and a common unit 78. The modular units 76 and the common units 78 are of various functions. In the common units 78, reference numerals used in the specification and the drawings are used to refer to individual types where individual types of each unit are required to be specified.

As shown in FIG. 21, as a common unit 78, there is provided a main shaft support 79, a main shaft spindle 80 and a slide table 81 capable of advancing and retracting in two directions perpendicular to each other. The slide table 81 includes a first table 81a capable of advancing and retracting in a predetermined axial direction (a Z-axis direction) and a second table 81b capable of advancing and retracting in a direction (an X-axis direction) perpendicular to the above described axial direction, which are mounted in two stages on a bed 77, and a drive source such as a servo motor or the like for each of the axial directions.

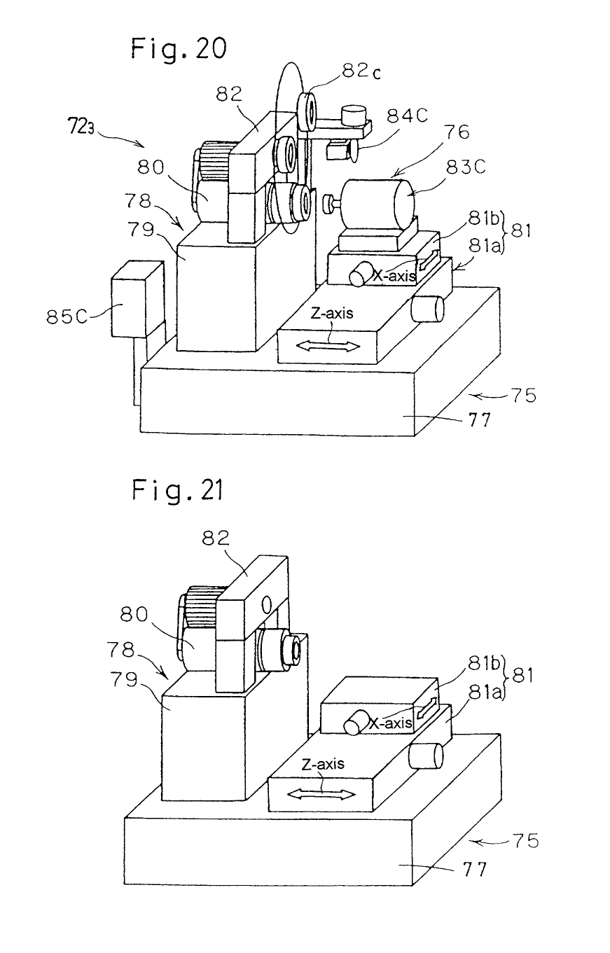

A loading unit 82 may be either structured as to provide the process machine 75 as one of the common units 78, or structured as one of interchangeable modular units. Where the loading unit 82 is rendered to be a common unit 78, a loading unit body thereof is rendered to be a common unit and jigs such as loader chucks 82a to 82c (FIGS. 18 to 20) and others are to be used as interchangeable jigs.

Where as shown in FIG. 18 the production facility 72 of the dedicated unitary equipment is rendered to be an inner race groove grinder 72₁, relative to the process machine 75 of the common specification, dedicated interchangeable components 82a are assembled with a grindstone spindle 83A, a swiveling rotary dresser 84A and the loading unit 82 as a dedicated modular unit 76.

Where as shown in FIG. 19 the production facility 72 of the dedicated unitary equipment is rendered to be an inner race inner periphery grinder 72₂, relative to the process machine 75 of the common specification, a dedicated grindstone spindle 83B, a fixed dresser 84B, dedicated interchangeable components 82b for the loading unit 82 and an after-process-gauge 85B are fitted.

Where as shown in FIG. 20 the production facility 72 of the dedicated unitary equipment is rendered to be an outer race groove grinder 72₃, relative to the process machine 75 of the common specification, a dedicated grindstone spindle 83C, a swiveling rotary dresser 84C, dedicated interchangeable components 82c for the loading unit 82 and an after-process-gauge 85C are fitted.

It is to be noted that although the grindstone spindles 83A to 83C which serve as dedicated modular units 76 may be of the same structure, it is preferred for them to have different functions since powers required by the processing vary from each other. Also, each of the grindstone spindles 83A to 83C is preferably in the form of a built-in motor type. With respect to the main shaft spindle 80, it may be either a built-in type or a type different for each motor. Again, these motors are preferably of a type capable of being driven by an inverter. The loading unit 82 may be of a design in which the whole thereof constitutes one of the modular units 76. Since the slide table 81 is such that if a main shaft position remains the same, the stroke position required varies depending on whether it is used as the inner groove grinder 72₁ or whether it is used as the inner race inner periphery grinder 72₂, the slide table 81 used in the process machine 75 is preferably of a type having a stroke range that can accommodate any of those cases.

As discussed above, the production facility 72 of the dedicated unitary equipment in the production line 71 can be assembled by assembling the dedicated modular unit 76 to the process machine 75 of the common specification and can provide a dedicated machine having a different function by changing the dedicated modular units 76. For this reason, the process step can be changed easily. In the example discussed above, the inner race groove grinder 72₁, the inner race inner periphery grinder 72₂ and the outer race groove grinder 72₃ can be freely interchanged relative to each other.

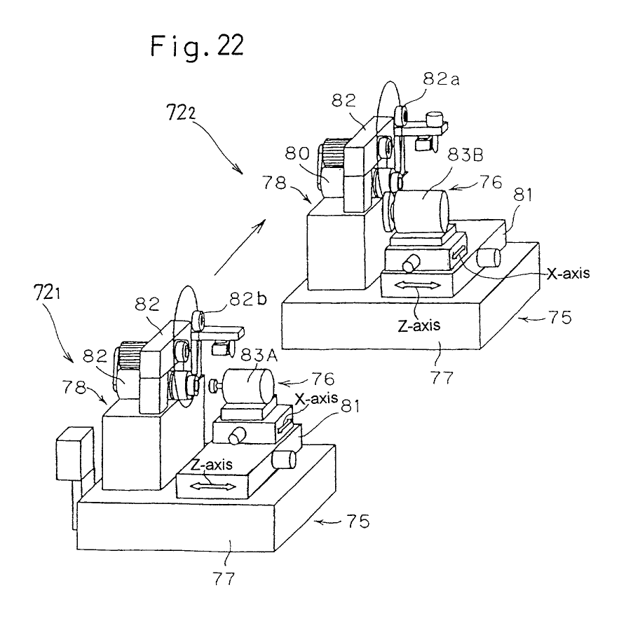

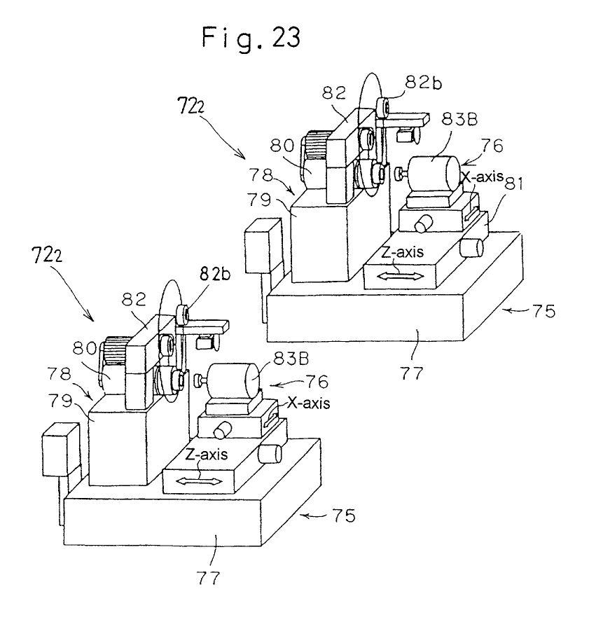

Because of the reason discussed above, for example, in the first production line 71₁ as shown in FIGS. 17 and 22, the arrangement in which the inner race inner periphery grinder 72₂ is positioned at a location corresponding to the process step subsequent to the inner race groove grinder 72₁ can be modified to the arrangement in which as shown in FIG. 23 two inner race inner periphery grinders 72₂ are arranged in juxtaposed fashion. In such case, the work before the inner periphery grinding is carried out may be selectively supplied to the two inner race inner periphery grinders 72₂ to thereby increase the production tact of the production line 71₁. An inner race groove grinding is carried out at a different production line.

Where the loading unit 82 is provided on the process machine 75 of a common specification, since delivery and transport positions I and O (FIGS. 18 and 19) of the loading unit 82 are fixed, the transport devices 73₂ (FIG. 17) can have the same structure even though the production facility 72 is changed in morphology to a different dedicated machine and, therefore, the process step can further easily be performed.

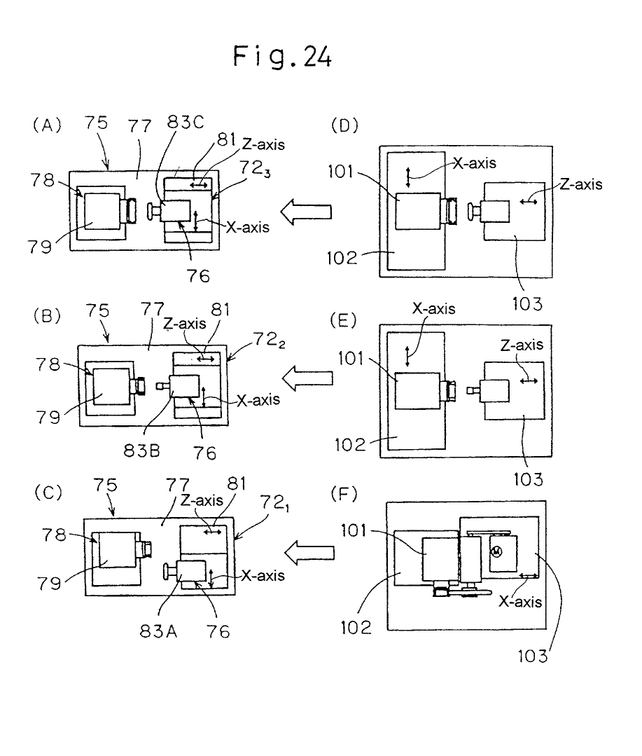

FIG. 24 is an explanatory diagram showing comparison of the production facilities 72, which serve as the various grinders used in this embodiment, with the conventional standard grinder.

(A) to (C) in this figure illustrate the outer race groove grinder 72₃, the inner race inner periphery grinder 72₂ and the inner race groove grinder 72₁, respectively, whereas (D) to (F) illustrate the conventional outer race groove grinder, the conventional inner race inner periphery grinder and the conventional inner race groove grinder, respectively.

While the conventional dedicated machines are of different designs, the dedicated machines used in this embodiment are unified in their fundamental style as a result that the process machine 75 is rendered to be common to each other and, therefore, their morphologies can easily be changed. Also, while in the prior art the dedicated machines are separated into a cutting bench 102, on which the main shaft support 101 is mounted, and a grindstone bench 103, what is employed in this embodiment is the two stage slide table 81 wherein the cutting bench and the grindstone bench are integrated together, to thereby rendering it to be compact in structure. Also, in the illustrated embodiment, the spindles 80 and 83A to 83C are of a build-in motor type and, in combination with the employment of the two-stage type slide table 81, the facility is assembled compact.

It is to be noted that jigs such as the main shaft chucks and tools in the process machine 75 of the common specification of the production facilities 72 of the dedicated unitary equipment are interchangeable. Also, jigs and tools in the modular units 76 are also interchangeable. A slight change of the products to be manufactured can be accommodated by change of accessories such as those jigs and tools.

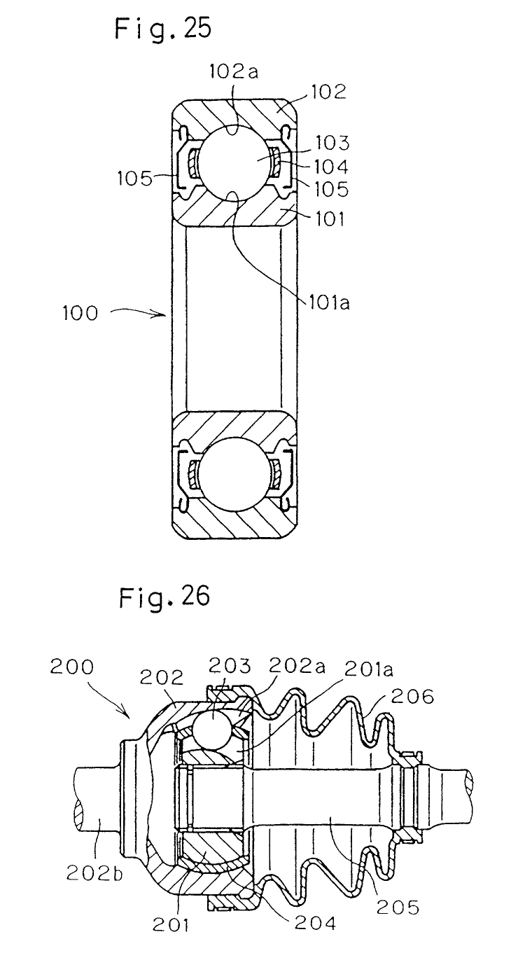

FIG. 25 illustrates an example of a rolling bearing assembly which is a product manufactured in the above described workshop 4. This rolling bearing assembly 100 is of a design in which a plurality of rolling elements 103 are interposed between an inner race 101 and an outer race 102. The rolling elements 103 are retained by a retainer or cage 104. A seal 105 is provided on each of opposite ends of the bearing assembly. Where the above described rolling bearing assembly 100 is to be produced in the production lines 71 shown in FIGS. 17 to 23, the inner race groove grinder 72₁ shown in FIG. 18 is used to grind an inner race groove 101a of the inner race 101, and the outer race groove grinder 72₃ shown in FIG. 20 is used to grind an outer race groove 102a of the outer race 102.

FIG. 26 illustrates an example of a constant speed joint which is another example of a product manufactured in the above discussed workshop 4. This constant speed joint 200 is of a design in which a rolling element 203, which is a torque transmitting ball, is interposed between track grooves 201a and 202a extending axially of the inner race 201 and the outer race 20, respectively. The rolling element 203 is retained by a retainer or cage 204. The outer race 202 has one end open the outside and is sealed by a boot 206 capped between it and a shaft 205 coupled with the inner race 201. The outer race 202 has the opposite end to which a shaft portion 202b is connected.

In the case of a mechanical component having such a rolling element 103 and 203 like the rolling bearing assembly 100 or the constant speed joint 200 or the like, dedicated production lines are planned for each product or a group of product types in the mass productivity, cost, preciseness and others. Also, even in the same workshop 4, it may be required to manufacture products that cannot be changed during planning, and in such case, a line change is to be carried out. For this reason, there are considerable effects brought about by reduction of the developing time for the line setup resulting from the employment of the virtual workshop system 11 and the above described workshop facility designing and operating method and the large area workshop production management system, optimization of the production activity and reduction in cost and shortening of the delivery time resulting from the production planning in which production is shared to the workshops 4 in the various sites.

It is to be noted that the products manufactured in the workshop 4 may be, in the case of the bearing assembly, other than that described above, a wheel bearing (an angular unit, a so-called second generation, third generation or fourth generation wheel bearing), a cylindrical roller bearing, a tapered roller bearing or the like. Also, for the constant velocity joint, it may be a fixed joint, a sliding joint (including a tripole type) or the like.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. A workshop facility designing and operating method which comprises a virtual workshop verifying process of formulating a virtual workshop that is a data model of an existing or newly established workshop having a portion or the whole that is newly designed and for verifying a production state by means of a simulating means by causing the virtual workshop to perform a quasi-production activity; a workshop deployment process of constructing an actual workshop utilizing a data model of the virtual workshop so verified, and a remote monitoring process of remote monitoring the actual workshop so constructed and comparing a result of remote monitoring and the verification performed during the virtual workshop verifying process.

2. A workshop facility designing and operating method which comprises a virtual workshop verifying process of formulating a virtual workshop that is a data model of an existing or newly established workshop having a portion or the whole that is newly designed, functions of a manufacturing facility or process step and a physical distributing facility of process step and information on a layout of these facilities and for verifying a production state and a physical distribution state on the layout by means of a simulating means by causing the virtual workshop to perform a quasi-production activity; a workshop deployment process of constructing an actual workshop utilizing the facilities and the layout in the data model of the virtual workshop so verified, and a remote monitoring process of remote monitoring the production state and the physical distribution state of the facilities in the layout employed in the actual workshop so constructed and comparing a result of remote monitoring and the verification performed during the virtual workshop verifying process.

3. The workshop facility designing and operating method as claimed in claim 2, wherein the virtual workshop includes a plurality of virtual facilities, which are models of individual facilities, and wherein the simulating means has a facility simulating section for verifying each of the virtual facilities and an overall simulating section for unifying results of verification of the individual facilities performed by the facility simulating section to thereby apply them to the layout.

4. The workshop facility designing and operating method as claimed in claim 3, wherein the facility simulating section for the virtual facilities of a production facility is capable of setting an operating condition and an adjusting condition settable of the production facility and also capable of verifying appropriate to the operating condition and the adjusting condition that has been set.

5. The workshop facility designing and operating method as claimed in claim 1, wherein during the verifying process performed by the simulating means a quality of a product being produced is one of items that are to be verified.

6. The workshop facility designing and operating method as claimed in claim 1, wherein the facility simulating section is capable of performing verification by causing a program for executing procedures of operating the production facility to be quasi-executed.

7. The workshop facility designing and operating method as claimed in claim 1, wherein the simulating means is capable of performing verification corresponding to change in process step resulting from change in morphology of the facility of the workshop.

8. The workshop facility designing and operating method as claimed in claim 1, wherein the plural production facilities are a dedicated unitary equipment in which modular units are interchangeably fitted one at a time to a common process machine and the simulating means is capable of performing verification corresponding to change of the modular units.

9. The workshop facility designing and operating method as claimed in claim 1, wherein during the virtual workshop verifying process verification according to an operating calendar condition and verification corresponding to an abnormality occurring in the facility are carried out.

10. The workshop facility designing and operating method as claimed in claim 4, wherein during the workshop deployment process, information on operating conditions set during the virtual workshop verifying process is transmitted as an instruction through a data communication means to the production facility and a production step.

11. The workshop facility designing and operating method as claimed in claim 1, wherein during the remote monitoring process a remote maintenance of the facility is performed with use of a result of monitoring.

12. The workshop facility designing and operating method as claimed in claim 11, wherein if there is a difference between the result of monitoring and the result of verification, the simulating means verifies the production state by causing the virtual workshop to perform a quasi-production activity again and the remote maintenance is carried out according to the result of verification.

13. A workshop facility design and operation support system, which comprises:
a virtual workshop system including a virtual workshop authoring means for authoring a virtual workshop that is a model constructed according to layout information on functions of various production facilities and physical distribution facilities of a workshop, and a simulating means for verifying a production state and a physical distribution state on the layout by causing the virtual workshop to perform a quasi-production activity; and
a remote monitoring means for remote monitoring the production state and the physical distribution state of the facilities in the layout employed in an actual workshop constructed according to the model of the virtual workshop so verified.

14. The workshop facility design and operation support system as claimed in claim 13, wherein the virtual workshop system is connected with a facility database registered therein information associated with the facility and the virtual workshop authoring means authors the virtual workshop according to information acquired from the facility database.

15. The workshop facility design and operation support system as claimed in claim 13, further comprising a link means for performing a link process between the virtual workshop system and a remote monitoring system.

16. The workshop facility design and operation support system as claimed in claim 13, wherein a product to be manufactured in the workshop is a mechanical component having a rolling element.

17. A virtual workshop system which is a system for verifying a workshop wherein a plurality of production facilities are a dedicated unitary equipment having modular units that can be interchangeably fitted one at a time to a process machine of a common specification, which system comprises:
a virtual workshop authoring means for authoring a virtual workshop that is a data model of a workshop, and a simulating means for verifying at least a production state and a physical distribution state by causing the virtual workshop so authored to perform a quasi-production activity, wherein the simulating means is capable of verifying the production state and the physical distribution state when the modular units of the production facility are changed.

18. A virtual workshop system which is a system for verifying a workshop wherein a plurality of production facilities are a dedicated unitary equipment having modular units that can be interchangeably fitted one at a time to a process machine of a common specification, while some of production facilities are arranged in a plural number to define a production line, which system comprises:
a virtual workshop authoring means for authoring a virtual workshop that is a data model constructed based on information on functions of various production facilities and physical distribution facilities of the workshop and an layout of those facilities, and a simulating means for verifying a production state and a physical distribution state on the layout by causing the virtual workshop so authored to perform a quasi-production activity, wherein the simulating means is capable of performing verification corresponding to various changes in a production line including exchange of modular units of the production facility.

19. The virtual workshop system as claimed in claim 17, wherein the virtual workshop authoring means is capable of authoring a model of the dedicated unitary equipment in which the modular units are changed, in reference to information on the process machine of the production facility registered in a facility database and information on the modular units.

20. The virtual workshop system as claimed in claim 18, wherein the virtual workshop includes a plurality of virtual facilities that are models of the individual facilities, and wherein the simulating means includes a facility simulating section for verifying the virtual facilities and an overall simulating means for unifying results of verification of the individual facilities performed by the facility simulating section to thereby apply them to the layout.

21. The virtual workshop system as claimed in claim 20, wherein the facility simulating section for the virtual facilities of a production facility is capable of setting an operating condition and an adjusting condition settable of the production facility and also capable of verifying appropriate to the operating condition and the adjusting condition that has been set.

22. A virtual workshop-remote monitoring link system which comprises a virtual workshop system as defined in claim 17, a remote monitoring system for remote monitoring an actual workshop corresponding to this virtual workshop, and a link means for performing a linking process between the virtual workshop system and the remote monitoring system, wherein the remote monitoring system is capable of performing a remote maintenance.

23. The virtual workshop-remote monitoring link system as claimed in claim 22, wherein the remote monitoring system is capable of interactively performing a remote monitoring and a remote maintenance, capable of displaying an image of an operator at a workshop side and alphanumeric information to be used for monitoring or remote maintenance in side-by-side fashion and also capable of transmitting with voice.

24. The virtual workshop system as claimed in claim 17, wherein a product to be manufactured in the workshop is a mechanical component having a rolling element.

25. The workshop facility design and operation support system as claimed in claim 22, wherein a product to be manufactured in the workshop is a mechanical component having a rolling element.

26. A workshop-verifying system complex comprising an actual workshop and a virtual workshop system,
wherein the actual workshop includes a production line defined by production facilities and physical distribution facilities, a plurality of production facilities form respective line constituent elements, each facility being a dedicated unitary equipment in which modular units are interchangeably fitted one at a time to a common process machine, and
wherein the virtual workshop system is a virtual workshop system as defined in claim 17.

27. A production line comprising a plurality of production facilities and a plurality of physical distribution facilities, the plural production facilities form respective line constituent elements, each facility being a dedicated unitary equipment in which modular units are interchangeably fitted one at a time to a common process machine, and a process step can be changed by changing the modular units of the production facilities.

28. The production line as claimed in claim 27, wherein the common process machine in the dedicated unitary equipment includes a common bed and a common unit.

29. The production line as claimed in claim 27, wherein a production machine comprising the dedicated unitary equipment comprises a grinding machine.

30. The production line as claimed in claim 27, wherein the common process machine in the grinding machine comprises a bed, a main shaft support, a main shaft spindle and slide table capable of advancing and retracting in two axial directions perpendicular to each other, wherein a modular unit of a grindstone spindle is mounted on the slide table.

31. The production line as claimed in claim 27, wherein the production facility comprising the dedicated unitary equipment comprises a grinding machine for grinding a bearing ring in a rolling bearing assembly, said production facility having a morphology capable of changing into one of a dedicated machine for grinding an inner peripheral surface of an inner race, a dedicated machine for grinding a raceway groove of the inner race, and a dedicated machine for grinding a raceway groove of an outer race by changing a modular unit.

32. The production line as claimed in claim 27, wherein the common process machine in the dedicated unitary equipment includes common loading units.

33. The production line as claimed in claim 27, wherein as one of the modular unit, there is a spindle device unit, said spindle device unit being of a built-in motor type.

34. A method of changing a process step in a production line comprising a plurality of production facilities and a plurality of physical distribution facilities, wherein the plural production facilities form respective line constituent elements, each facility being a dedicated unitary equipment in which modular units are interchangeably fitted one at a time to a process machine of a common specification, a process step being changed by changing one of the modular units of the production facilities.

35. The production line process step changing method as claimed in claim 34, wherein the production line at a plurality of workshops is such that the plural production facilities form respective the line constituent elements, each facility being a dedicated unitary equipment in which modular units are interchangeably fitted one at a time to a process machine of a common specification, a process step being changed by changing one of the modular units of the production facilities.

36. A large area workshop production management system which comprises a united virtual workshop system including a plurality of virtual workshop systems unified together, said plural virtual workshop systems corresponding to respective actual workshops at various places, a united remote monitoring system for remote monitoring a production record of each of the actual workshop at the various places, a collective order control and management system for controlling and managing order information at various business establishments, a physical distribution controlling and monitoring system for controlling and monitoring physical distribution state at the various places, and a production planning means;
wherein each of the virtual workshop system is comprised of a simulating means for verifying a production state by causing the virtual workshop, that is a data model of the actual workshop, to perform a quasi-production activity, and
wherein the production planning means is operable to formulate a production plan to be shared by the actual workshops, according to information acquired from the united virtual workshop system, the united remote monitoring system, the collective order control and management system and the physical distribution controlling and monitoring system and also operable to give a production instruction to each of the actual workshop based on the production plan so formulated.

37. The large area workshop production management system as claimed in claim 36, wherein the production planning means is operable to cause the united virtual workshop system to perform verification based on information acquired from the united remote monitoring system, the order control and management system and the physical distribution controlling and monitoring system and also operable to automatically formulate a production plan to be shared by the workshops according to a result of such verification.

38. The large area workshop production management system as claimed in claim 36, wherein some of the actual workshops at the various places have a capability of changing a process step and the united virtual workshop system is capable of verifying a production state when the process step is changed.

39. The large area workshop production management system as claimed in claim 36, wherein some of the actual workshops at the various places is provided with, as production facilities, dedicated unitary equipments in which modular units are interchangeably fitted one at a time to a process machine of a common specification, and wherein the united virtual workshop system is capable of verifying a production state when the process step is changed as a result of change of the modular units of the actual workshops.

40. The virtual workshop system as claimed in claim 39, wherein the virtual workshop system includes a virtual workshop authoring means capable of authoring a mode of various dedicated unitary equipments in which modular units are changed, in reference to information on the process machine of the production facility registered in a facility controlling database and information on the modular units.

41. The large area workshop production management system as claimed in claim 36, wherein the production planning means is capable of formulating a production plan according to a predetermined standard, with respect to predefined items including a production cost, a physical distribution, a material, a tax and so on.

42. The large area workshop production management system as claimed in claim 36, wherein the united remote monitoring system is capable of acquiring information on at least a production record, a state of products in process, a stock of component parts available and a working state of the actual workshop.

43. The large area workshop production management system as claimed in claim 36, wherein the production planning means is capable of transmitting a processing technique support information such as information on processing conditions or address information of storage area of a database in which processing conditions are registered and others, together with the production instruction.

44. The large area workshop production management system as claimed in claim 36, wherein the united remote monitoring system has a function of performing a remote maintenance.

45. The large area workshop production management system as claimed in claim 36, further comprising a facility controlling database in which information on facilities and process steps in various actual workshops subject to a production plan, information on management, operating procedures and unique information on individual facilities are registered.

46. The large area workshop production management system as claimed in claim 36, wherein the production planning means is capable of performing an automatic repairing by which, in the event of an occurrence of a trouble in one of the facilities, a process step in the production line and the operating procedures of the production facilities can be changed through the united remote monitoring system so that a delay caused in such facility can be compensated for others of the facilities.

47. The large area workshop production management system as claimed in claim 36, wherein the production planning means has a function of monitoring a progress of the production activity through the united remote monitoring system and automatically adjusting a line tact of the production line.

48. The large area workshop production management system as claimed in claim 36, wherein a product to be manufactured in the workshop is a mechanical component having a rolling element.

49. A unified production management large area workshop facility comprising actual workshops at various places, a large area workshop production management system for performing a production management of those actual workshops, and a communication network means for communicating between the actual workshops and the large area workshop production management system,
wherein the large area workshop production management system is a large area workshop management system as defined in claim 36, and wherein each of the actual workshops includes means for transmitting information on at least a production record to a united remote monitoring system in the large area workshop production management system.

50. The unified production management large area workshop facility as claimed in claim 49, wherein the actual workshop include monitoring sensors for securing monitoring information on at least a working state of a facility within the workshop and means for transmitting the monitoring information, acquired from the monitoring sensors, to the large area workshop production management system through the communication network means.

51. The unified production management large area workshop facility as claimed in claim 49, wherein the large area workshop production management system is a large area workshop management system as defined in claim 39, and wherein some of the actual workshops at the various places is provided with, as production facilities, dedicated unitary equipments in which modular units are interchangeably fitted one at a time to a process machine of a common specification, and wherein the united virtual workshop system is capable of verifying a production state when the process step is changed as a result of change of the modular units of the actual workshops.
